(19) United States
(12) Patent Application Publication
(10) Pub. No.: US 2026/0070056 A1
(43) Pub. Date: Mar. 12, 2026

(54) FLOW CELLS WITH HYDROPHOBIC FLUID GUIDE

(71) Applicant: ILLUMINA, INC., San Diego, CA (US)

(72) Inventor: Tyler Dill, San Diego, CA (US)

(21) Appl. No.: 19/320,275

(22) Filed: Sep. 5, 2025

Related U.S. Application Data
(60) Provisional application No. 63/693,472, filed on Sep. 11, 2024.

(51) Int. Cl. B01L 3/00

(52) U.S. Cl. CPC B01L 3/50273; B01L 2300/0654; B01L 2300/0874; B01L 2300/165; B01L 2400/0463

(57) ABSTRACT

An example of a flow cell includes a substrate having an active region that is directly adjacent to an inactive region. The active region includes a hydrophilic material disposed within a plurality of first depressions that are separated by first interstitial regions. The inactive region includes a fluidic pinning region that is directly adjacent to the active region. The inactive region further includes a plurality of second depressions that are separated by second interstitial regions, wherein at least some of the plurality of second depressions are directly adjacent to the fluidic pinning region. The inactive region still further includes a hydrophobic barrier positioned over at least the plurality of second depressions. The hydrophobic barrier includes a hydrophobic polymer.

### CROSS-REFERENCE TO RELATED APPLICATIONS

This application claims the benefit of U.S. Provisional Application Ser. No. 63/693,472, filed Sep. 11, 2024, the contents of which is incorporated by reference herein in its entirety.

### REFERENCE TO SEQUENCE LISTING

The instant application contains a Sequence Listing which has been submitted electronically in XML file format and is hereby incorporated by reference in its entirety. Said XML copy, created on Aug. 30, 2025 is named ILI283B_IP-2804-US_Sequence_Listing.xml and is 17,778 bytes in size.

### BACKGROUND

Various protocols in biological or chemical research involve performing a large number of controlled reactions on local support surfaces or within predefined reaction chambers, or active areas/regions. The reactions may then be observed or detected, and subsequent analysis may help identify or reveal properties of chemicals involved in the controlled reactions. In some examples, the reactions generate fluorescence, and thus an optical system that is configured for fluorescence detection may be used to analyze the controlled reactions. In other examples, the reactions generate electrical signals, and thus a detection system that is configured for electrical signal detection may be used to analyze the controlled reactions.

### SUMMARY

Disclosed herein are flow cells that utilize hydrophobic fluid guides and fluidic pinning methods/structures. The hydrophobic fluid guides and the fluidic pinning methods/structures disclosed herein may be used to maintain various materials, such as polymeric hydrogels, biological sequencing reagents, etc., within an active region of a flow cell substrate. The hydrophobic fluid guides and the fluidic pinning methods/structures disclosed herein may further be used to prevent various materials from spreading into undesired regions of a flow cell substrate during flow cell use or preparation, such as inactive regions. The ability to exclude various materials from undesired regions of a flow cell substrate may be advantageous, e.g., for preventing liquids within two separate, respective active regions in a single flow cell lane from mixing with one another, or for improving bonding at bonding regions of a flow cell substrate, or for many other examples that are enhanced by fluidic control.

Overall, the hydrophobic fluid guides and fluidic pinning methods/structures disclosed herein can be used to prepare flow cell substrates that facilitate versatile and accurate fluidic flow thereover.

### BRIEF DESCRIPTION OF THE DRAWINGS

Features of examples of the present disclosure will become apparent by reference to the following detailed description and drawings, in which like reference numerals correspond to similar, though perhaps not identical, components. For the sake of brevity, reference numerals or features having a previously described function may or may not be described in connection with other drawings in which they appear.

FIG. 1A is a top view of an example of a flow cell;

FIG. 1B is an enlarged, and partially cutaway view of an example of a flow cell substrate including two active regions that are separated by an intervening inactive region within a single flow channel, where each of the active regions includes a plurality of first depressions defined therein, and where the inactive region includes (i) two separate fluidic pinning regions that are respectively and directly adjacent to the two active regions, and (ii) second depressions defined therein that are at least partially filled with a hydrophobic barrier;

FIG. 1C is an enlarged, and partially cutaway view of an example of a flow cell substrate including an active region having two separate inactive regions directly adjacent thereto (i.e., at opposed edges of the active region) in a single lane, where the active region includes a plurality of first depressions defined therein, and where the inactive regions each include (i) a fluidic pinning region that is directly adjacent to the active region, and (ii) second depressions defined therein that are at least partially filled with a hydrophobic barrier;

FIG. 1D is a simplified top view of the flow cell architecture that is depicted in FIG. 1B;

FIG. 1E is a simplified top view of the flow cell architecture that is depicted in FIG. 1C;

FIG. 2 is a schematic illustration of a complementary metal oxide semiconductor (CMOS) chip that is coupled to a flow cell substrate;

FIG. 3A through FIG. 3E collectively show a schematic illustration of various examples of a method disclosed herein, where FIG. 3A depicts a plurality of first depressions defined in an active region of a substrate and a plurality of second depressions defined in inactive regions of a substrate, FIG. 3B depicts the introduction of a surface functionality to the substrate of FIG. 3A, FIG. 3C depicts the introduction of a hydrophilic material to the active region of the substrate of FIG. 3B, FIG. 3D depicts the introduction of a hydrophobic material to the inactive regions of the substrate of FIG. 3C, and FIG. 3E depicts the substrate of FIG. 3D after a polishing process has been performed;

FIG. 4A through FIG. 4E collectively show a schematic illustration of various examples of another method disclosed herein, where FIG. 4A depicts a plurality of first depressions defined in an active region of a substrate and a plurality of second depressions defined in inactive regions of a substrate, FIG. 4B depicts the introduction of a surface functionality to the substrate of FIG. 4A, FIG. 4C depicts the introduction of a hydrophobic material to the inactive regions of FIG. 4B, FIG. 4D depicts the introduction of a hydrophilic material to the active region of the substrate of FIG. 4C, and FIG. 4E depicts the structure of FIG. 4D after a polishing process has been performed;

FIG. 5A through FIG. 5I collectively show a schematic illustration of various examples of yet another method disclosed herein, where FIG. 5A depicts a plurality of first depressions defined in an active region of a substrate and a plurality of second depressions defined in inactive regions of a substrate, FIG. 5B depicts the introduction of a surface functionality to the substrate of FIG. 5A, FIG. 5C depicts the introduction of a hydrophilic material to the active region of the substrate of FIG. 5C, FIG. 5D depicts the substrate of FIG. 5C after a polishing process has been performed, FIG. 5E depicts the introduction of a protective coating over the active region of the substrate of FIG. 5D, FIG. 5F depicts the introduction of a surface functionality to the inactive regions of the substrate of FIG. 5E, FIG. 5G depicts the introduction of a hydrophobic material to the inactive regions of the substrate of FIG. 5F, FIG. 5H depicts the substrate of FIG. 5G after a polishing process has been performed, and FIG. 5I depicts the substrate of FIG. 5H after the protective coating has been removed from the active region of the substate of FIG. 5H;

FIG. 6A through FIG. 6H collectively show a schematic illustration of various examples of still another method disclosed herein, where FIG. 6A depicts a plurality of first depressions defined in an active region of a substrate and a plurality of second depressions defined in inactive regions of a substrate, FIG. 6B depicts the introduction of a surface functionality to the substrate of FIG. 6A, FIG. 6C depicts the introduction of a hydrophilic material to the active region and to the inactive region(s) of the substrate of FIG. 6C, whereby the hydrophilic material at least partially fills the plurality of first depressions and second depressions, FIG. 6D depicts the substrate of FIG. 6C after a polishing process has been performed, FIG. 6E depicts the introduction of a protective coating over the active region of the substrate of FIG. 6D, FIG. 6F depicts the introduction of a hydrophobic material to the inactive regions of the substrate of FIG. 6E, whereby the hydrophobic material attaches to the hydrophilic material within the second depressions, FIG. 6G depicts the substrate of FIG. 6F after a polishing process has been performed, and FIG. 6H depicts the substrate of FIG. 6G after the protective coating has been removed from the active region of the substate of FIG. 6G; and

FIG. 7A through FIG. 7I collectively show a schematic illustration of various examples of still another method disclosed herein, where FIG. 7A depicts a plurality of first depressions defined in an active region of a substrate and a plurality of second depressions defined in inactive regions of a substrate, FIG. 7B depicts the introduction of a surface functionality to the substrate of FIG. 7A, FIG. 7C depicts the introduction of a hydrophilic material to the active region of the substrate, whereby the hydrophilic material at least partially fills the plurality of first depressions in the active region, FIG. 7D depicts the substrate of FIG. 7C after a polishing process has been performed, FIG. 7E depicts the introduction of a protective coating over the active region of the substrate of FIG. 7D, FIG. 7F depicts the introduction of a surface functionality to the inactive regions of the substrate of FIG. 7E, FIG. 7G depicts the introduction of a hydrophobic material to the inactive regions of the substrate of FIG. 7F, whereby the hydrophobic material at least partially fills the plurality of second depressions in the inactive regions, FIG. 7H depicts the substrate of FIG. 7G after a polishing process has been performed, and FIG. 7I depicts the substrate of FIG. 7H after the protective coating has been removed from the active region.

### DEFINITIONS

It is to be understood that terms used herein will take on their ordinary meaning in the relevant art unless specified otherwise. Several terms used herein and their meanings are set forth below.

The singular forms “a”, “an”, and “the” include plural referents unless the context clearly dictates otherwise.

The terms comprising, including, containing and various forms of these terms are synonymous with each other and are meant to be equally broad.

The terms top, bottom, lower, upper, on, adjacent, etc. are used herein to describe the flow cell and/or the various components of the flow cell. It is to be understood that these directional terms are not meant to imply a specific orientation, but are used to designate relative orientation between components. The use of directional terms should not be interpreted to limit the examples disclosed herein to any specific orientation(s).

The terms first, second, etc. also are not meant to imply a specific orientation or order, but rather are used to distinguish one component from another.

An “acrylamide monomer” refers to a monomer with the structure

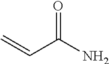

or a monomer including an acrylamide group. Examples of the monomer including an acrylamide group include azido acetamido pentyl acrylamide:

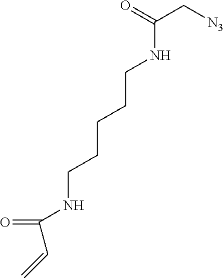 [SMILES: C=CC(=O)NCCCCCNC(=O)CN=[N+]=[N-]]

### and N-isopropylacrylamide:

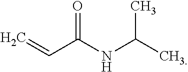

Other acrylamide monomers may be used.

The terms “active area” or “active region,” as used interchangeably herein, refer to the region of a substrate where (i) a hydrophilic material, such as a polymeric hydrogel, is positioned, and (ii) where a desired reaction can be carried out. The active areas described herein include a plurality of (first) depressions (referred to as “first depressions 26” or “depressions 26” herein) that are separated by (first) interstitial regions (referred to as “first interstitial regions 28” or “interstitial regions 28” herein). Further, the active areas described herein include, or are configured to spatially accommodate, a polymeric hydrogel that is capable of attaching primers (or that has primers attached thereto) and that can participate in a desired reaction, such as nucleic acid template amplification. One or more active regions may be in fluid communication with a flow channel.

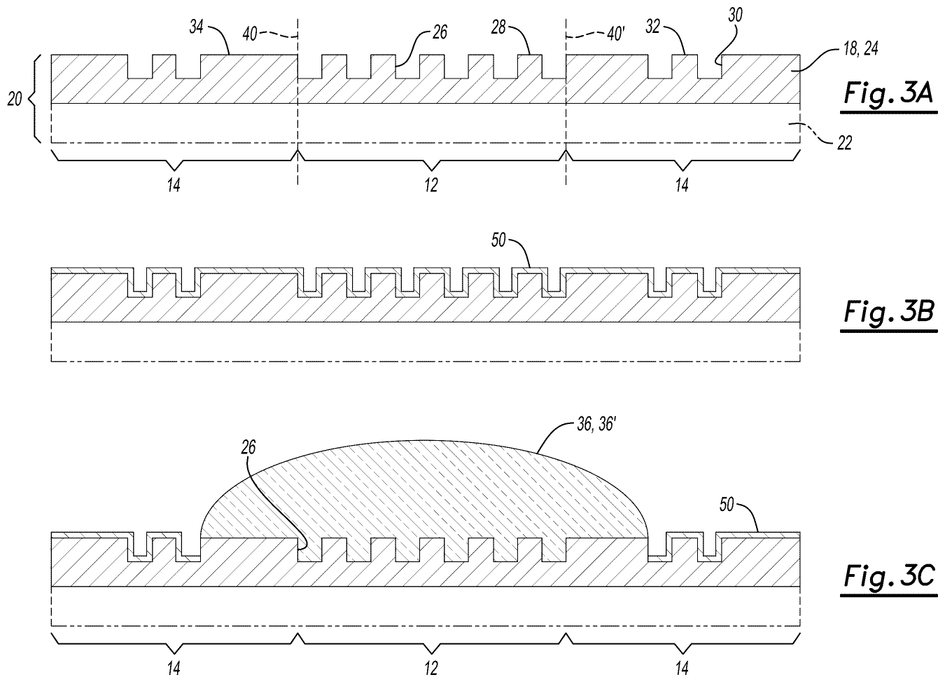

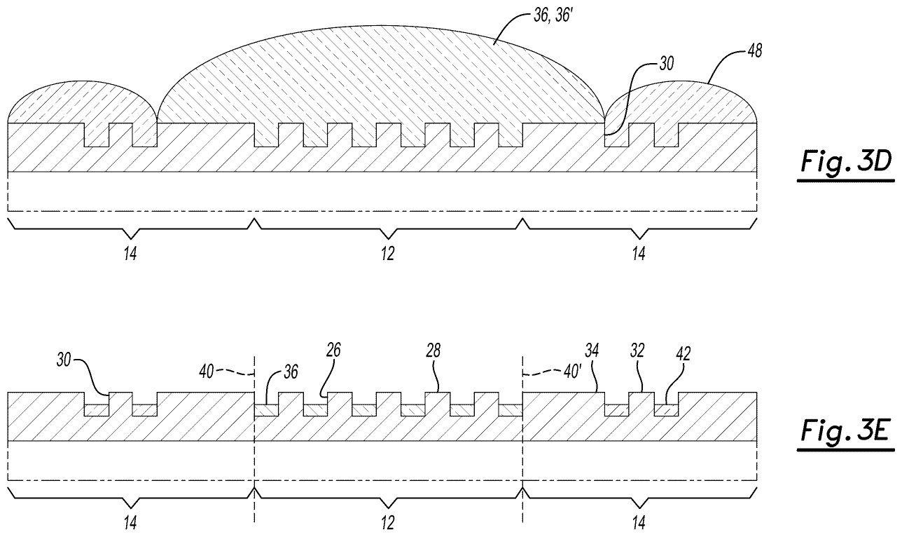

The term “activation,” as used herein, refers to a process that generates reactive groups at the surface of a single-layer substrate or an outermost layer of a multi-layer substrate. Activation may be accomplished using silanization (e.g., exposure to a silane-inclusive solution or mixture) and/or plasma ashing. Throughout the figures illustrating various methods, the functional groups resulting from activation are sometimes identified by reference numeral 50 (see, e.g., FIG. 3B). During the methods, it is to be understood that these functional groups may undergo chemical interaction or reaction with a subsequently applied material. As such, in figures depicting such interaction or reaction (see, e.g., FIG. 3D) and in subsequent figures in that series (e.g., FIG. 3D and FIG. 3E), the functional groups are not labeled. Though the chemical structure of the functional groups is not explicitly shown in the figures, when activation of a surface is performed, it is to be understood that silane groups or —OH functional groups become introduced to the surface. These functional groups can then be used to covalently attach a material, such as a polymeric hydrogel or a hydrophobic material/polymer, to the surface that includes the functional groups.

An “aldehyde,” as used herein, refers to an organic compound containing a functional group with the structure —CHO, which includes a carbonyl center (i.e., a carbon double-bonded to oxygen), with the carbon atom also being bonded to hydrogen and an R group (such as an alkyl or other side chain). The general structure of an aldehyde is:

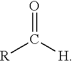

As used herein, “alkyl” refers to a straight or branched hydrocarbon chain that is fully saturated (i.e., contains no double or triple bonds). The alkyl group may have 1 to 20 carbon atoms. Example alkyl groups include methyl, ethyl, propyl, isopropyl, butyl, isobutyl, tertiary butyl, pentyl, hexyl, and the like. As an example, the designation “C1-4 alkyl” indicates that there are one to four carbon atoms in the alkyl chain, i.e., the alkyl chain is selected from the group consisting of methyl, ethyl, propyl, iso-propyl, n-butyl, isobutyl, sec-butyl, and tert-butyl.

As used herein, “alkenyl” refers to a straight or branched hydrocarbon chain containing one or more double bonds. The alkenyl group may have 2 to 20 carbon atoms. Example alkenyl groups include ethenyl, propenyl, butenyl, pentenyl, hexenyl, and the like.

As used herein, “alkyne” or “alkynyl” refers to a straight or branched hydrocarbon chain containing one or more triple bonds. The alkynyl group may have 2 to 20 carbon atoms.

As used herein, “aryl” refers to an aromatic ring or ring system (i.e., two or more fused rings that share two adjacent carbon atoms) containing only carbon in the ring backbone. When the aryl is a ring system, every ring in the system is aromatic. The aryl group may have 6 to 18 carbon atoms. Examples of aryl groups include phenyl, naphthyl, azulenyl, and anthracenyl.

An “amino” functional group refers to an —NRₐR_{b} group, where Rₐ and R_{b} are each independently selected from hydrogen

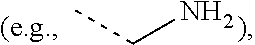

C1-6 alkyl, C2-6 alkenyl, C2-6 alkynyl, C3-7 carbocycle, C6-10 aryl, 5-10 membered heteroaryl, and 5-10 membered heterocycle, as defined herein.

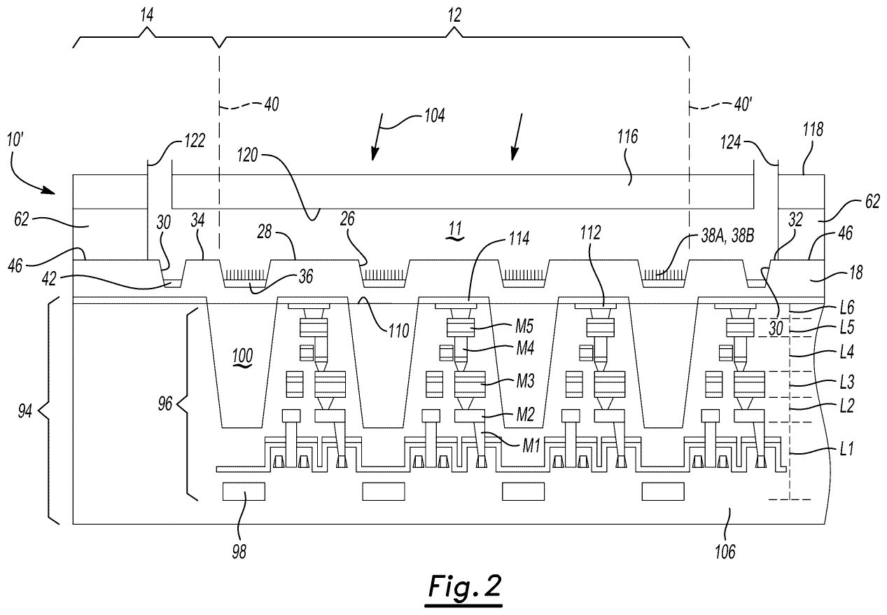

As used herein, the term “attached” refers to the state of two things being joined, fastened, adhered, connected, or bound to each other, either directly or indirectly, and either physically or chemically. As an example of chemical attachment, a nucleic acid can be attached to a polymeric hydrogel by a covalent or non-covalent bond. A covalent bond is characterized by the sharing of pairs of electrons between atoms. A non-covalent bond is a physical bond that does not involve the sharing of pairs of electrons and can include, for example, hydrogen bonds, ionic bonds, van der Waals forces, hydrophilic interactions, and hydrophobic interactions. As an example of physical attachment, in enclosed versions of the flow cell disclosed herein, a lid may be attached to a patterned structure (e.g., at one or more bonding regions) (see the lid 116 in FIG. 2, which is “attached” to the single-layer substrate 18 via a spacer layer 62).

An “azide” or “azido” functional group refers to —N₃.

As used herein, a “bonding region” refers to an area of a substrate that is to be bonded to another material, which may be, as examples, a spacer layer, a lid, another substrate, etc., or combinations thereof (e.g., a spacer layer and a lid, or a spacer layer and another substrate). The bond that is formed at the bonding region may be a chemical bond (as described above), or a mechanical bond (e.g., using a fastener, etc.). The bonding region is free of surface chemistry (e.g., polymeric hydrogel and primers of a primer set), and exclusion of the surface chemistry from the bonding region may be facilitated, in part, by the hydrophobic barriers disclosed herein.

As used herein, “carbocycle” means a non-aromatic cyclic ring or ring system containing only carbon atoms in the ring system backbone. When the carbocycle is a ring system, two or more rings may be joined together in a fused, bridged or spiro-connected fashion. Carbocycles may have any degree of saturation, provided that at least one ring in a ring system is not aromatic. Thus, carbocycles include cycloalkyls, cycloalkenyls, and cycloalkynyls. The carbocycle group may have 3 to 20 carbon atoms. Examples of carbocycle rings include cyclopropyl, cyclobutyl, cyclopentyl, cyclohexyl, cyclohexenyl, 2,3-dihydro-indene, bicyclo[2.2.2]octanyl, adamantyl, and spiro[4.4]nonanyl.

As used herein, the term “carboxylic acid” or “carboxyl” refers to —COOH.

As used herein, “cycloalkyl” refers to a completely saturated (no double or triple bonds) mono- or multi-cyclic hydrocarbon ring system. When composed of two or more rings, the rings may be joined together in a fused fashion. Cycloalkyl groups can contain 3 to 10 atoms in the ring(s). In some examples, cycloalkyl groups can contain 3 to 8 atoms in the ring(s). A cycloalkyl group may be unsubstituted or substituted. Example cycloalkyl groups include cyclopropyl, cyclobutyl, cyclopentyl, cyclohexyl, cycloheptyl, and cyclooctyl.

As used herein, “cycloalkenyl” or “cycloalkene” means a carbocycle ring or ring system having at least one double bond, wherein no ring in the ring system is aromatic. Examples include cyclohexenyl or cyclohexene and norbornenyl or norbornene. Also as used herein, “heterocycloalkenyl” or “heterocycloalkene” means a carbocycle ring or ring system with at least one heteroatom in ring backbone, having at least one double bond, wherein no ring in the ring system is aromatic.

As used herein, “cycloalkynyl” or “cycloalkyne” means a carbocycle ring or ring system having at least one triple bond, wherein no ring in the ring system is aromatic. An example is cyclooctyne. Another example is bicyclononyne. Also as used herein, “heterocycloalkynyl” or “heterocycloalkyne” means a carbocycle ring or ring system with at least one heteroatom in ring backbone, having at least one triple bond, wherein no ring in the ring system is aromatic.

The term “depositing,” as used herein, refers to any suitable application technique, which may be manual or automated, and, in some instances, results in modification of the surface properties. Generally, depositing may be performed using vapor deposition techniques, coating techniques, grafting techniques, or the like. Some specific examples include chemical vapor deposition (CVD), spray coating (e.g., ultrasonic spray coating), spin coating, dunk or dip coating, doctor blade coating, puddle dispensing, flow through coating, flow through deposition, aerosol printing, screen printing, microcontact printing, inkjet printing, or the like. In one example, deposition is performed using a selective or a high-precision coating method, such as aerosol printing, screen printing, microcontact printing, inkjet printing, or one that involves the use of a precision gantry tool.

As used herein, the term “depression” refers to a discrete concave or recessed feature defined in a substrate and having a surface opening. In some instances, the surface opening is at least partially surrounded by interstitial region(s) of the substrate. Depressions can have any of a variety of shapes at their opening in a surface including, as examples, round, elliptical, square, polygonal, star-shaped (with any number of vertices), etc. The cross-section of a depression taken orthogonally with the surface can be curved, square, polygonal, hyperbolic, conical, angular, etc. In some examples, the depression can be a well or two interconnected wells. Some of the depressions disclosed herein are disposed within an active region of a flow cell and include surface chemistry. These depressions are referred to herein as “first depressions.” Other depressions disclosed herein are disposed within an inactive region of a flow cell, are directly adjacent to a fluidic pinning region, and may include a hydrophobic barrier. These depressions are referred to herein as “second depressions.”

The term “epoxy” as used herein refers to

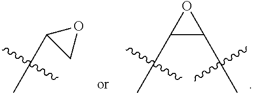

As used herein, the term “flow cell” is intended to refer to a vessel having an enclosed flow channel where a reaction can be carried out, or a vessel that is open to a surrounding environment and in which a reaction can be carried out. A flow cell with an enclosed channel also includes an inlet for delivering (a) reagent(s) to the channel and an outlet for removing (a) reagent(s) from the channel. In some examples, the flow cell enables the detection of the reaction that occurs therein. For example, the flow cell can include one or more transparent surfaces allowing for the optical detection of arrays, optically labeled molecules, or the like. As another example, the flow cell can include a complementary metal oxide semiconductor chip coupled thereto, allowing for the electrical detection of arrays, optically labeled molecules, or the like. The flow cells disclosed herein include hydrophobic barriers that are used to control fluidic flow over portions of the substrate(s) that make up the flow cell.

As used herein, a “flow channel,” “channel,” or “lane” refers to a flow cell area that can selectively receive a liquid sample, reagents, etc. In some examples disclosed herein, the terms refer to an area that is defined between two patterned structures, and the flow channel (or lane) is in fluid communication with surface chemistry disposed within depressions on either of the two substrates. In other examples disclosed herein, the flow channel is defined between one substrate and a lid, and the flow channel is in fluid communication with surface chemistry within depressions of the one substrate. Alternatively, the terms may refer to a discrete area on a surface of an open-wafer substrate defined by one or more active regions, where the one or more active regions defining the flow channel can receive a liquid (sample). In any example, the flow channels or lanes are in fluid communication with one or more active regions of the flow cell.

As used herein, a “fluidic pinning region” is a substantially planar area, e.g., of an inactive region of a substrate, that is used in combination with a plurality of depressions (i.e., the depressions in an active region and the depressions in an inactive region) to create differential surface energy that facilitates high-precision fluidic pinning between active regions and inactive regions. Fluidic pinning regions are free of depressions, do not include additional chemical modification, and have a predetermined width.

As used herein, “heteroaryl” refers to an aromatic ring or ring system (i.e., two or more fused rings that share two adjacent atoms) that contain(s) one or more heteroatoms, that is, an element other than carbon, including but not limited to, nitrogen, oxygen and sulfur, in the ring backbone. When the heteroaryl is a ring system, every ring in the system is aromatic. The heteroaryl group may have 5-18 ring members.

As used herein, “heterocycle” means a non-aromatic cyclic ring or ring system containing at least one heteroatom in the ring backbone. Heterocycles may be joined together in a fused, bridged or spiro-connected fashion. Heterocycles may have any degree of saturation provided that at least one ring in the ring system is not aromatic. In the ring system, the heteroatom(s) may be present in either a non-aromatic or aromatic ring. The heterocycle group may have 3 to 20 ring members (i.e., the number of atoms making up the ring backbone, including carbon atoms and heteroatoms). In some examples, the heteroatom(s) are O, N, or S.

The term “hydrazine” or “hydrazinyl” as used herein refers to a —NHNH₂ group.

The term “hydrazone” or “hydrazonyl,” as used herein, refers to a

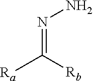

group in which Rₐ and R_{b} are each independently selected from hydrogen, C1-6 alkyl, C2-6 alkenyl, C2-6 alkynyl, C3-7 carbocycle, C6-10 aryl, 5-10 membered heteroaryl, and 5-10 membered heterocycle, as defined herein.

As used herein, “hydroxy” or “hydroxyl” refers to an —OH group.

The term “hydrogel” or “polymeric hydrogel” refers to a semi-rigid polymer that is permeable to liquids and/or gases. The hydrogel can swell when liquid (e.g., water) is taken up and that can contract when liquid is removed, e.g., by drying. While a hydrogel may absorb water, it is not water-soluble.

As used herein, the term “inactive region” refers to an area, e.g., of a substrate, that includes (second) depressions and a fluidic pinning region. The second depressions included in the inactive region may include a hydrophobic barrier disposed therein or thereover. Inactive regions are directly adjacent to the active regions described herein and may be used to maintain fluids within (a) respective, directly adjacent active region(s).

As used herein, the term “interstitial region” refers to an area, e.g., of a substrate that separates individual depressions within an active region of a flow cell from other depressions within the active region (these are referred to herein as “first interstitial regions 28” or “interstitial regions 28”). Interstitial regions may also separate depressions within an inactive region from one another (these are referred to herein as “second interstitial regions 32” or “interstitial regions 32”). The separation provided by an interstitial region can be partial or full separation.

“Nitrile oxide,” as used herein, means a “RₐC≡N⁺O⁻” group in which Rₐ is defined herein. Examples of preparing nitrile oxide include in situ generation from aldoximes by treatment with chloramide-T or through action of base on imidoyl chlorides [RC(Cl)═NOH] or from the reaction between hydroxylamine and an aldehyde.

“Nitrone,” as used herein, means a

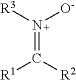

group in which R¹, R², and R³ may be any of the Rₐ and R_{b} groups defined herein, except that R³ is not hydrogen (H).

As used herein, a “nucleotide” includes a nitrogen-containing heterocyclic base, a sugar, and one or more phosphate groups. Nucleotides are monomeric units of a nucleic acid sequence. In RNA (ribonucleic acid), the sugar is a ribose, and in DNA (deoxyribonucleic acid), the sugar is a deoxyribose, i.e., a sugar lacking a hydroxyl group that is present at the 2′ position in ribose. The nitrogen containing heterocyclic base (i.e., nucleobase) can be a purine base or a pyrimidine base. Purine bases include adenine (A) and guanine (G), and modified derivatives or analogs thereof. Pyrimidine bases include cytosine (C), thymine (T), and uracil (U), and modified derivatives or analogs thereof. The C-1 atom of deoxyribose is bonded to N-1 of a pyrimidine or N-9 of a purine. A nucleic acid analog may have any of the phosphate backbone, the sugar, or the nucleobase altered. Examples of nucleic acid analogs include, for example, universal bases or phosphate-sugar backbone analogs, such as peptide nucleic acid (PNA).

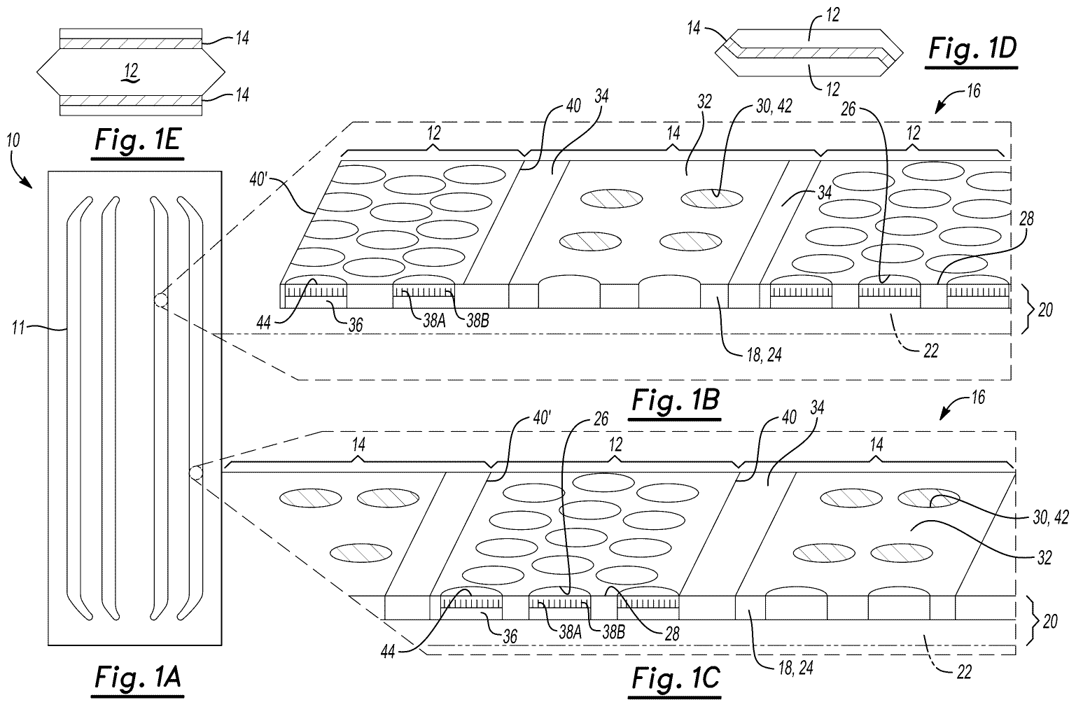

In some examples, the term “over” may mean that one component or material is positioned directly on another component or material. When one is directly on another, the two are in physical contact with each other. For example, in FIG. 1B, when the multi-layer substrate 20 is used, the layer 24 is directly over the base support 22, with no intervening materials therebetween.

In other examples, the term “over” may mean that one component or material is positioned indirectly on another component or material. By indirectly on, it is meant that a gap or an additional component or material may be positioned between the two components or materials. For example, in FIG. 1B, when the multi-layer substrate 20 is used, the primers 38A, 38B are indirectly over the base support 22, as the polymeric hydrogel 36 is positioned between the primers 38A, 38B and the base support 22.

A “patterned structure” refers to a substrate that includes (an) active region(s) and (an) inactive region(s). In some examples, the substrate is exposed to patterning techniques (e.g., etching, lithography, etc.) in order to generate the pattern(s) within the active region(s) and the inactive region(s). However, the term “patterned structure” is not intended to imply that such patterning techniques have to be used to generate the pattern. The patterned structure may be generated via any of the methods disclosed herein.

As used herein, the term “polyhedral oligomeric silsesquioxane” (an example of which is commercially available under the tradename “POSS”) refers to a chemical composition that is a hybrid intermediate (e.g., RSiO_{1.5}) between that of silica (SiO₂) and silicone (R₂SiO). An example of polyhedral oligomeric silsesquioxane may be that described in Kehagias et al., Microelectronic Engineering 86 (2009), pp. 776-778, which is incorporated by reference in its entirety. In an example, the composition is an organosilicon compound with the chemical formula [RSiO_{3/2}]ₙ, where the R groups can be the same or different. Example R groups for POSS include epoxy, azide/azido, a thiol, a poly(ethylene glycol), a norbornene, a tetrazine, acrylates, and/or methacrylates, or further, for example, alkyl, aryl, alkoxy, and/or haloalkyl groups.

As used herein, the “primer” is defined as a single stranded nucleic acid sequence (e.g., single stranded DNA). Some primers, referred to herein as amplification primers, serve as a starting point for template amplification and cluster generation. Other primers, referred to herein as sequencing primers, serve as a starting point for DNA synthesis. The 5′ terminus of the primer may be modified to allow a coupling reaction with a functional group of a polymeric hydrogel. The primer length can be any number of bases long and can include a variety of non-natural nucleotides. In an example, the sequencing primer is a short strand, ranging from 10 to 60 bases, or from 20 to 40 bases.

As used herein, the term “protective coating” refers to a water-soluble material in the form of a solid (e.g., a thin film), or a gel, or a liquid that is applied on the active area of a substrate. The protective coating may be any water-soluble material that does not deleteriously affect the underlying surface chemistry or substrate and that serves to protect and/or preserve the functionality of the active area. A water-soluble protective coating is, by definition, distinguishable from a polymeric hydrogel, as the protective coating dissolves when exposed to water, and may be washed away in this manner; while the polymeric hydrogel may be water-insoluble. The protective coating may at least substantially prevent a hydrogel layer (and primers attached thereto) from undergoing deleterious changes during processing and/or shipping and/or storage. For another example, the protective coating may preserve the accessibility of the primer and/or at least substantially prevent degradation of the polymeric hydrogel.

A “spacer layer,” as used herein refers to a material that bonds two components together. In some examples, the spacer layer can be a radiation-absorbing material that aids in bonding, or can be put into contact with a radiation-absorbing material that aids in bonding.

The term “substrate” may be used herein in conjunction with the term “single-layer substrate” or “multi-layer substrate.” A single-layer substrate is one layer of a support material that can be patterned with depressions (referred to herein as a “single-layer substrate 18” or “substrate 18”). The multi-layer substrate includes at least two layers, e.g., a base support with an additional layer thereon that can be patterned with depressions (referred to herein as a “multi-layer substrate 20” or “substrate 20,” which includes the base support 22 and the layer 24).

“Surface chemistry,” as defined herein, refers to a hydrophilic material, such as a polymeric hydrogel (as defined herein), which may have at least one primer attached thereto. Surface chemistry may be positioned within first depressions of (an) active region(s) of a flow cell.

“Surface functionality,” as defined herein, refers to functional groups present at a surface of a material or introduced to a surface of a material, which facilitates attachment of another material to the surface.

The term “tantalum pentoxide” refers to the inorganic compound with the formula Ta₂O₅. This compound is transparent, having a transmittance ranging from about 0.25 (25%) to 1 (100%), to wavelengths ranging from about 0.35 μm (350 nm) to at least 1.8 μm (1800 nm). A “tantalum pentoxide substrate” may comprise, consist essentially of, or consist of Ta₂O₅. In examples where it is desirable for the tantalum pentoxide substrate to transmit electromagnetic energy having any of these wavelengths, the substrate may consist of Ta₂O₅ or may comprise or consist essentially of Ta₂O₅ and other components that will not interfere with the desired transmittance of the substrate.

A “thiol” functional group refers to —SH.

As used herein, the terms “tetrazine” and “tetrazinyl” refer to six-membered heteroaryl group comprising four nitrogen atoms. Tetrazine can be optionally substituted.

“Tetrazole,” as used herein, refers to five-membered heterocyclic group including four nitrogen atoms. Tetrazole can be optionally substituted.

The term “transparent” when describing a material (e.g., substrate, layer, etc.) means that that the material allows light of a particular wavelength or range of wavelengths to pass through. Transparency may be quantified using transmittance, i.e., the ratio of light energy falling on a body to that transmitted through the body. The transmittance of a transparent material will depend upon the thickness of the material and the wavelength of light. In the examples disclosed herein, the transmittance of the transparent material may range from 0.25 (25%) to 1 (100%). The material may be a pure material, a material with some impurities, or a mixture of materials, as long as the resulting material is capable of the desired transmittance. Additionally, depending upon the transmittance of the material, the time for light exposure and/or the output power of the light source may be increased or decreased to deliver a suitable dose of light energy through the transparent material to achieve the desired effect.

### DETAILED DESCRIPTION

Flow cells used in nucleic acid sequencing include one or more substrates having (an) active region(s) that include(s) a hydrophilic material, such as a polymeric hydrogel. The polymeric hydrogel may have oligonucleotide primers grafted thereto, and amplification, cluster generation, and sequencing can take place within the active region(s). In enclosed examples of the flow cells disclosed herein, the substrate forms a patterned structure that is be bonded to a lid or to another patterned structure, e.g., at one or more bonding regions, to create a flow channel for delivering reagents to the active region(s). In these examples, it is often desirable for the bonding region(s) to be free of the hydrophilic materials included in the active region(s). In open-wafer examples of the flow cells disclosed herein, the substrate is not bonded to a lid or to another substrate (and thus does not include a bonding region), but the substrate still includes surface chemistry within one or more active region(s) of the substrate. In these examples, it is often desirable to deliver reagents within a particular active region, such that the reagents do not become applied (and do not mix with fluids) in another active region, such as an active region included in an adjacent lane.

Further, in both enclosed and open-wafer versions of the flow cell disclosed herein, it may be desirable for (at least) two separate active regions to be included within a single lane or flow channel of a flow cell, where the (at least) two active areas are separated by a hydrophobic barrier. This flow cell structure facilitates the flow of (at least) two separate fluids within respective active regions of the single lane or flow channel of the flow cell. In other words, two separate fluids can be applied to desired portions of a flow cell substrate, e.g., during a flow-through process, without the separate fluids mixing with one another.

Still further, the methods and flow cell structures disclosed herein may utilize a protective coating that is positioned over one or more flow cell active areas and that may be included in the flow cell prior to/during shipping and/or storage. When the protective coating is utilized during the methods disclosed herein, the protective coating may be used to prevent materials (i.e., hydrophilic or hydrophobic materials) from being applied to particular substrate regions, such as active regions and/or inactive regions, during flow cell preparation processes.

Overall, the hydrophobic barrier-inclusive flow cells and the fluidic pinning methods/structures disclosed herein facilitate the flow of various materials (i.e., hydrogels, sequencing reagents, etc.) over desired flow cell substrate areas, while facilitating the exclusion of the various materials from other flow cell substrate areas. The structure of the hydrophobic barrier-inclusive flow cell and methods of forming/using the hydrophobic barrier-inclusive flow cell will now be described.

### Flow Cell Structures

Examples of the flow cell disclosed herein generally comprise a substrate including an active region that is directly adjacent to an inactive region, wherein the active region includes a hydrophilic material disposed within a plurality of first depressions that are separated by first interstitial regions, and wherein the inactive region includes a fluidic pinning region that is directly adjacent to the active region, a plurality of second depressions that are separated by second interstitial regions, wherein at least some of the plurality of second depressions are directly adjacent to the fluidic pinning region, and a hydrophobic barrier positioned over at least the plurality of second depressions, wherein the hydrophobic barrier includes a hydrophobic polymer.

FIG. 1A depicts an example of the flow cell 10 disclosed herein from a top view. The flow cell 10 includes one or more active region(s) 12 and one or more inactive region(s) 14 (see FIG. 1B and FIG. 1C), which are directly adjacent to each other within a flow channel 11 (which may be referred to herein as a lane). The number of active regions 12 and inactive regions 14 within the flow channel(s) 11 depend, in part, upon the flow cell 10 structure that is being used.

For example, FIG. 1B depicts an example of a flow cell 10 architecture in which two different active regions 12 are separated by an inactive region 14 within a single flow channel 11. A simplified top view of this architecture is shown in FIG. 1D. This flow cell 10 structure may be used to facilitate the flow of at least two different fluids within respective active regions 12 of a single flow channel 11, without the different fluids mixing with one another (due at least in part to the presence of the intervening inactive region 14, which includes a hydrophobic barrier 42).

As another example, FIG. 1C depicts a flow cell 10 architecture in which a single active region 12 is directly adjacent to two separate inactive regions 14 within a single flow channel 11. As shown in the figure, the two inactive regions 14 are respectively positioned on opposite sides (i.e., opposite edges 40, 40′) of the active region 12, and a simplified top view of this architecture is shown in FIG. 1E. This flow cell 10 structure may be used to facilitate the flow of one or more hydrophilic materials within the active region 12, without the one or more hydrophilic materials spreading into other regions of the flow cell 10 (due at least in part to the inactive regions 14, which include the hydrophobic barrier 42).

In any example of the flow cell 10, the flow cell 10 includes a patterned structure 16, which may be a single-layer substrate 18 or a multi-layer substrate 20 that includes a base support 22 and an additional layer 24 positioned directly over the base support 22. The patterned structure 16 includes a plurality of first depressions 26 (separated by first interstitial regions 28) within the active region(s) 12, and the patterned structure 16 further includes a plurality of second depressions 30 (separated by second interstitial regions 32) within the inactive region(s) 14. The inactive region(s) 14 also include the (planar) fluidic pinning region 34, which is directly adjacent to at least one active region 12 at an edge 40 or 40′ of the active region 12, as shown in FIG. 1B and FIG. 1C.

The depressions 26, 30 may be defined in the patterned structure 16 using a suitable technique, such as nanoimprint lithography, photolithography, etching, etc. As will be described in more detail herein, the first depressions 26 within the active region(s) 12 include a hydrophilic material, which may be included as part of a surface chemistry (e.g., a polymeric hydrogel 36 having primers 38A, 38B attached thereto). As will also be described in more detail herein, the second depressions 30 within the inactive region(s) 14 include a hydrophobic barrier 42.

Enclosed examples of the flow cell 10 disclosed herein may include one patterned structure 16 bonded to a lid, e.g., at one or more bonding regions (lid and bonding region(s) not shown in FIG. 1A through FIG. 1E), or one patterned structure 16 bonded to a second patterned structure (second patterned structure not shown) via the spacer layer at the bonding region(s). Open-wafer examples of the flow cell 10 include a single patterned structure 16 that is open to the surrounding environment.

In enclosed versions of the flow cell 10, the spacer layer used to attach the patterned structure 16 and the lid, or used to attach the patterned structure 16 to the second patterned structure, may be any material that will seal portions of the patterned structure 16 and the lid or that will seal portions of the patterned structure 16 and the second patterned structure. As examples, the spacer layer may be an adhesive, a radiation-absorbing material that aids in bonding, or the like. In some examples, the spacer layer is the radiation-absorbing material, e.g., KAPTON® black.

In both enclosed and open-wafer versions of the flow cell 10, the patterned structure 16 of the flow cell 10 may be the single-layer substrate 18, or the patterned structure 16 may be the multi-layer substrate 20 including a base support 22 having the layer 24 positioned thereon.

Examples of suitable materials for the single-layer substrate 18 include siloxanes (e.g., epoxy siloxane), glass, modified or functionalized glass, polymeric materials (including acrylics, polystyrene and copolymers of styrene and other materials, polypropylene, polyethylene, polybutylene, polyurethanes, polytetrafluoroethylene (such as TEFLON® from Chemours), polyethylene terephthalate (PET), polycarbonate, cyclic olefins/cyclo-olefin polymers (COP) (such as ZEONOR® from Zeon), polyimides, nylon (polyamides), etc.), ceramics/ceramic oxides, silica (i.e., silicon dioxide (SiO₂)), fused silica, or silica-based materials, aluminum silicate, silicon and modified silicon (e.g., boron doped p+ silicon), silicon nitride (Si₃N₄), tantalum pentoxide (Ta₂O₅) or other tantalum oxide(s) (TaOₓ), hafnium oxide (HfO₂), carbon, metals, resins, or the like. Examples of suitable resins include inorganic oxides, such as tantalum pentoxide (e.g., Ta₂O₅) or other tantalum oxide(s) (TaOₓ), aluminum oxide (e.g., Al₂O₃), silicon oxide (e.g., SiO₂), hafnium oxide (e.g., HfO₂), indium tin oxide, titanium dioxide, etc., or polymeric resins, such as a polyhedral oligomeric silsesquioxane based resin (e.g., POSS® from Hybrid Plastics), a non-polyhedral oligomeric silsesquioxane epoxy resin, a poly(ethylene glycol) resin, a polyether resin (e.g., ring opened epoxies), an acrylic resin, an acrylate resin, a methacrylate resin, an amorphous fluoropolymer resin (e.g., CYTOP® from Bellex), and combinations thereof.

It is to be understood that the material of the single-layer substrate 18 may be any material that can be etched or imprinted to form the (first) depressions 26 shown in FIGS. 1B and 1n FIG. 1C (e.g., within the active region(s) 12 of the flow cell 10) and to form the (second) depressions 30 shown in FIGS. 1B and 1n FIG. 1C (e.g., within the inactive region(s) 14 of the flow cell 10).

As mentioned, examples of the multi-layer substrate 20 include the base support 22 and at least one other layer 24 positioned thereon. Any example of the material of the single-layer substrate 18 may be used as the base support 22 of the multi-layer substrate 20. Examples of suitable materials for the layer 24 include inorganic oxides, such as tantalum oxide (e.g., Ta₂O₅), aluminum oxide (e.g., Al₂O₃), silicon oxide (e.g., SiO₂), or hafnium oxide (e.g., HfO₂), or polymeric resins, such as a polyhedral oligomeric silsesquioxane based resin (e.g., POSS® from Hybrid Plastics), a non-polyhedral oligomeric silsesquioxane epoxy resin, a poly(ethylene glycol) resin, a polyether resin (e.g., ring opened epoxies), an acrylic resin, an acrylate resin, a methacrylate resin, an amorphous fluoropolymer resin (e.g., CYTOP® from Bellex), and combinations thereof. It is to be understood that in examples of the flow cell 10 that include the substrate 20, the other layer 24 (positioned on the base support 22) may be any material that can be etched or imprinted to form the first depressions 26 (e.g., within the active region(s) 12 of the flow cell 10) and the second depressions 30 (e.g., within the inactive region(s) 14 of the flow cell 10).

Suitable deposition techniques for the material of the single-layer substrate 18 or for the materials of the components of the multi-layer substrate 20 (e.g., the base support 22 and the layer 24) include chemical vapor deposition, dip coating, dunk coating, spin coating, spray coating, puddle dispensing, ultrasonic spray coating, doctor blade coating, aerosol printing, screen printing, microcontact printing, etc. It is to be understood that the deposition technique(s) that is/are used may depend, in part, upon the material of the substrate 18 or the material of the components of the substrate 20.

Suitable patterning techniques for the material of the single-layer substrate 18 or for the layer 24 of the substrate 20 include photolithography, nanoimprint lithography (NIL), stamping techniques, embossing techniques, molding techniques, micro-etching techniques, etc. It is to be understood that the patterning technique(s) that is/are used may depend, in part, upon the material used for the single-layer substrate 18 or for the layer 24 of the multi-layer substrate 20. A specific example of a method of forming the depressions 26, 30 is described in more detail in regard to the method of FIG. 3A through FIG. 3E.

The single-layer substrate 18 or the base support 22 (of the multi-layer substrate 20) may be a circular sheet, a panel, a wafer, a die etc. having a diameter ranging from about 2 mm to about 300 mm, e.g., from about 200 mm to about 300 mm, or may be a rectangular sheet, panel, wafer, die etc. having its largest dimension up to about 10 feet (˜3 meters). For example, a die may have a width ranging from about 0.1 mm to about 10 mm. While example dimensions have been provided, it is to be understood that a single-layer substrate 18 or base support 22 with any suitable dimensions may be used.

The thickness of the layer 24 (when the multi-layer substrate 20 is used) is greater than the desired depth for the depressions 26, 30 formed therein.

As mentioned, the enclosed flow cells 10 include a flow channel 11 (sometimes referred to herein as a lane). In the enclosed flow cells 10, the flow channel(s) 11 is/are defined between the one patterned structure 16 and the lid or between the one patterned structure 16 and the second patterned structure, which are bonded together via the spacer layer at one or more bonding region(s). Thus, the flow channel(s) 11 in the enclosed form of the flow cell 10 is/are defined by the patterned structure 16, the spacer layer, and either the lid or the second patterned structure. Alternatively, examples of the open-wafer flow cell 10 include the single patterned structure 16. In these examples, the single-layer substrate 18 or the multi-layer substrate 20 that forms the patterned structure 16 is a planar surface having the depressions 26, 30 of the respective active and inactive regions 12, 14 defined therein.

The depth of the flow channel 11 in the enclosed versions of the flow cell 10 can be as small as a monolayer thick when microcontact, aerosol, or inkjet printing is used to deposit a separate material (e.g., the spacer layer) that defines at least a portion of the sidewalls of the flow channel 11. This depth could be thicker if the spacer layer is pre-formed or applied via another technique. For other examples, the depth of the flow channel 11 can be about 1 μm, about 10 μm, about 50 μm, about 100 μm, or more. In an example, the depth may range from about 10 μm to about 400 μm. In another example, the depth may range from about 10 μm to about 30 μm. In still another example, the depth is about 5 μm or less. It is to be understood that the depth of the flow channel 11 may be greater than, less than or between the values specified above.

Each flow channel 11 that is included in enclosed versions of the flow cell 10 may be in fluid communication with an inlet and an outlet (examples of which are shown at reference numerals 122, 124 in FIG. 2). It is to be understood that in the examples shown in FIG. 1D, each of the active regions 12 may be associated with a respective set of inlets 122 and outlets 124. This enables distinct sequencing reagents or other fluids to be introduced to the respective regions 12 during flow cell 10 use. The inlet(s) 122 and outlet(s) 124 of each flow channel 11 may be positioned at opposed ends of the flow cell 10. The inlet(s) 122 and outlet(s) 124 of the respective flow channels 11 may alternatively be positioned anywhere along the length and width of the flow channel 11 that enables desirable fluid flow.

In the enclosed versions of the flow cell 10, the inlet(s) 122 allow(s) fluid(s) to be introduced into desired active region(s) 12 of the flow channel 11, and the outlet(s) 124 allow(s) fluid(s) to be extracted from desired active region(s) 12 of the flow channel 11. Each of the inlet(s) 122 and outlet(s) 124 is/are fluidly connected to a fluidic control system (including, e.g., reservoirs, pumps, valves, waste containers, and the like) that controls fluid introduction and expulsion. Some examples of the fluids that may be introduced into the flow channel(s) 11 include reaction components (e.g., DNA sample, polymerases, sequencing primers, nucleotides, etc.), washing solutions, deblocking agents, protective coating removing solutions, etc.

The example flow cell 10 shown in FIG. 1A includes four flow channel 11, each of which is in fluid communication with one or more active region(s) 12. While four flow channels 11 are shown in FIG. 1A, it is to be understood that any number of flow channels 11 may be included in the flow cell 10 (e.g., a single flow channel 11, eight flow channels 11, etc.). In some instances, such as for the flow cell 10 structure shown in FIG. 1C, for each active region 12 that is included, an equivalent number of flow channels 11 may also be present. Alternatively, in other instances, such as for the flow cell 10 structure shown in FIG. 1B, multiple active regions 12 may be present within (or may define) respective, distinct portions of a single flow channel 11. In FIG. 1B, two separate, distinct active regions 12 are shown within a single flow channel 11, where the active regions 12 are separated by an inactive region 14 within the single flow channel 11. It is to be understood, however, that any number of active regions 12 (and intervening inactive regions 14) may be included within a single flow channel 11, depending on the desired flow cell 10 structure.

The flow channels 11 (when included) may have any desirable shape. In an example, the flow channel 11 has a substantially rectangular configuration with curved ends. The length of the flow channel(s) 11 depends, in part, upon the size of the substrate (e.g., 18 or 20, see FIG. 1B and FIG. 1C) used to form the patterned structure 16. The width of the flow channel(s) 11 depends, in part, upon the size of the substrate 18, 20 used to form the patterned structure 16, the desired number of flow channel(s) 11, the desired number of depressions 26, 30 within an individual flow channel 11, the dimensions of the active region(s) 12 and inactive region(s) 14, and the desired space at a perimeter of the patterned structure(s) 16 that make(s) up the flow cell 10.

In both open and enclosed versions of the flow cell 10, the flow channel(s) 11 (and the active region(s) 12 and inactive region(s) 14 therein) may be sized and shaped to direct fluids, e.g., that are to be used in biological sequencing operations, over the active region(s) 12, such that the fluids are maintained within the active region(s) 12 and do not advance past the fluidic pinning region(s) 34 of the inactive region(s) 14. The height of the flow channel 11 and/or other dimensions of the flow channel 11 may be configured to maintain a substantially even flow of the fluid over the depressions 26. The dimensions of the flow channel 11 may also be configured to control bubble formation. The individual active region(s) 12 and inactive region(s) 14 within the flow channel(s) 11 may also have any desirable shape, which may be controlled using the methods described herein.

As shown in FIG. 1B, some examples of the flow cell 10 include a substrate 18, 20 in which two separate active regions 12 are positioned within a single flow channel 11, where each active region 12 has a plurality of first depressions 26 defined therein that include surface chemistry. The surface chemistry (within the active regions 12) includes a hydrophilic material. In an example, the hydrophilic material that is disposed within the plurality of first depressions 26 includes a polymeric hydrogel 36, which may have at least one primer 38A and/or 38B grafted thereto. Each of the first depressions 26 within the individual active regions 12 is separated from each other first depression 26 by interstitial regions 28. In examples, the interstitial regions 28 are free of the polymeric hydrogel 36 (and of the primers 38A, 38B). As will be described in more detail in regard to the methods disclosed herein, in some instances, portions of the substrate 18, 20 that define the active regions 12 may be activated (e.g., via silanization and/or plasma ashing). In these instances, the activation of the active regions 12 of the flow cell 10 facilitates attachment of the surface chemistry (e.g., the polymeric hydrogel 36 and the primers 38A, 38B) to the surface of the substrate 18, 20 at portions defining the active regions 12.

As further shown in FIG. 1B, the two separate, discrete active regions 12 (within the single flow channel 11) are separated by the inactive region 14 that is positioned therebetween. The inactive region 14 shown in FIG. 1B includes the plurality of second depressions 30 (which are separated by second interstitial regions 32) and the fluidic pinning regions 34. The second depressions 30 include a hydrophobic barrier 42 disposed therein. The fluidic pinning regions 34, which are substantially planar, are respectively and directly adjacent to an edge 40, 40′ of the active region 12 on either side of the inactive region 14, and these fluidic pinning regions 34 generate differential surface energy to facilitate pinning of (hydrophobic or hydrophilic) materials within the active regions 12. In the example shown in FIG. 1B, one active region 12 (within the single flow channel 11) may be isolated from the other active region 12 (by the inactive region 14), so that fluid introduced into one active region 12 does not flow into the indirectly adjacent active region 12.

As shown in FIG. 1C, other examples of the flow cell 10 include a substrate 18, 20 including a single active region 12 within a flow channel 11, the active region 12 including a plurality of first depressions 26 defined therein that include surface chemistry. As further shown in FIG. 1C, the surface chemistry (within the active region 12) includes the polymeric hydrogel 36 having at least one primer 38A and/or 38B grafted thereto. Each of the first depressions 26 within the active region 12 is separated from each other first depression 26 within the active region 12 by interstitial regions 28. In examples, the interstitial regions 28 are free of the hydrogel 36 (and of the primers 38A, 38B). As will be described in more detail in regard to the methods disclosed herein, in some instances, portions of the substrate 18, 20 that define the active region 12 may be activated (e.g., via silanization and/or plasma ashing). In these instances, the activation of the active region 12 of the flow cell 10 facilitates attachment of the surface chemistry (e.g., the polymeric hydrogel 36 and the primers 38A, 38B) to the surface of the substrate 18, 20 at portions defining the active region 12.

As further shown in FIG. 1C, this example of the flow cell 10 includes the two separate, discrete inactive regions 14 on either side of the active region 12 within the single flow channel 11. The inactive regions 14 shown in FIG. 1C each include the plurality of second depressions 30 (separated by second interstitial regions 32) and the fluidic pinning region(s) 34. The fluidic pinning region(s) 34 of the separate inactive regions 14, which are substantially planar, are respectively directly adjacent to the edges 40, 40′ of the active region 12 that is positioned between the inactive regions 14. The fluidic pinning regions 34 create differential surface energy to facilitate pinning of fluids within the active region 12. The second depressions 30 include the hydrophobic barrier 42, which also facilitates the pinning/control of fluids within the active region 12 between the inactive regions 14.

In either example, each active region 12 that is included in the flow cell 10 has opposed edges 40, 40′, where at least one of the edges 40, 40′ is directly adjacent to (the fluidic pinning region 34 of) an adjacent inactive region 14. The edges 40, 40′ are respectively defined between (i) the outermost depressions 26 in the active region(s) 12 and (ii) the portion(s) of the substrate 18 or 20 that define(s) the fluidic pinning region(s) 34 of the directly adjacent inactive region(s) 14. The edges 40, 40′ extend along a length of the substrate 18, 20, and are substantially parallel to the fluidic pinning region(s) 34.

Further, in either example, the inactive region(s) 14 include the (second) depressions 30, which are separated by (second) interstitial regions 32. While FIG. 1B and FIG. 1C depict inactive regions 14 that include two rows of (second) depressions 30, it is to be understood that any number of rows of depressions 30 may be included in the inactive regions 14 (e.g., three rows, five rows, ten rows, fifty rows, hundreds of rows, etc.). As such, the width of the portion of the inactive region 14 including the depressions 30 may vary depending, in part, upon the number of rows and the spacing between the rows. In one example, the width of the portion of the inactive region 14 including the depressions 30 is about 4 μm, and ten rows of depressions 30 are included.

The depressions 30 of the inactive region(s) 14 include the hydrophobic barrier 42, which may be formed from a hydrophobic material (such as a hydrophobic polymer). In an example, the hydrophobic barrier includes perfluoro (polytrimethylene) oxide trimethoxy silane (PPFTMS). In further examples, the hydrophobic barrier includes an alkylated polymer. The hydrophobic barrier 42 may form a layer across a bottom portion of the second depressions 30, or the hydrophobic barrier 42 may at least partially fill the second depressions 30, or the hydrophobic barrier 42 may fill an entirety of the plurality of second depressions 30. While not shown, it is to be understood that the hydrophobic barrier 42 may also extend over the interstitial regions 32 of the inactive region(s) 14.

The inactive region(s) 14 further include the fluidic pinning region(s) 34, where the fluidic pinning region(s) 34 is/are defined by a substantially planar portion of the surface of the substrate 18 or 20. As such, the fluidic pinning region(s) 34 do(es) not include second depressions 30 or any other physical pattern defined therein. The fluidic pinning region(s) 34 have/has a predetermined width. In an example, the predetermined width of the fluidic pinning region(s) 34 ranges from about 3 μm to about 200 μm. In another example, the predetermined width of the fluidic pinning region(s) 34 ranges from about 40 μm to about 100 μm. In one specific example, the predetermined width of the fluidic pinning region(s) 34 is about 70 μm.

The inactive region(s) 14 also have/has a predetermined width, which is defined by the width of the portion of the inactive region(s) 14 including the depressions 30 and the predetermined width of the fluidic pinning region(s) 34.

As mentioned, the depressions 26, 30 may be respectively formed in the active region(s) 12 and in the inactive region(s) 14 using any suitable patterning technique, such as stamping, nanoimprint lithography, photolithography, etching, etc.

Many different layouts of the first depressions 26 within the active region(s) 12 and/or second depressions 30 within the inactive region(s) 14 may be envisaged, including regular, repeating, and non-regular patterns. In an example, the first depressions 26 or second depressions 30 are disposed in a hexagonal grid for close packing and improved density. Other layouts may include, for example, rectilinear (rectangular) layouts, triangular layouts, and so forth. In some examples, the layout or pattern can be an x-y format in rows and columns. In other examples, the layout or pattern can be a repeating arrangement of first depressions 26 and the first interstitial regions 28 or of the second depressions 30 and second interstitial regions 32. In still other examples, the layout or pattern can be a random arrangement of the first depressions 26 and the first interstitial regions 28 or of the second depressions 30 and the interstitial regions 32.

The layout or pattern of first depressions 26 within the active region(s) 12 and of the second depressions 30 in the inactive region(s) 14 may be characterized with respect to the density (number) of the depressions 26, 30 in a defined area. For example, the depressions 26, 30 may be present at a density of approximately 2 million per mm². The density may be tuned to different densities including, for example, a density of about 100 per mm², about 1,000 per mm², about 0.1 million per mm², about 1 million per mm², about 2 million per mm², about 5 million per mm², about 10 million per mm², about 50 million per mm², or more, or less. It is to be further understood that the density can be between one of the lower values and one of the upper values selected from the ranges above, or that other densities (outside of the given ranges) may be used. As examples, a high-density array may be characterized as having the depressions 26, 30 separated by less than about 100 nm, a medium density array may be characterized as having the depressions 26, 30 separated by about 400 nm to about 1 μm, and a low density array may be characterized as having the depressions 26, 30 separated by greater than about 1 μm.

The layout or pattern of the depressions 26, 30 may also or alternatively be characterized in terms of the average pitch, or the spacing from the center of one depression 26, 30 to the center of an immediately adjacent depression 26, 30. The pattern can be regular, such that the coefficient of variation around the average pitch is small, or the pattern can be non-regular in which case the coefficient of variation can be relatively large. In either case, the average pitch can be, for example, about 50 nm, about 0.15 μm, about 0.5 μm, about 1 μm, about 5 μm, about 10 μm, about 100 μm, or more or less. The average pitch for a particular pattern of depressions 26, 30 can be between one of the lower values and one of the upper values selected from the ranges herein. It is to be understood that the pitch of the depressions 26 in the active region(s) 12 may be the same as or different than the pitch of the depressions 30 in the inactive region(s) 14. In an example, the pitch may be narrower in the inactive region(s) 14 than in the active region(s) 12.

In an example, the depressions 26, 30 have a pitch (center-to-center spacing) of about 1.5 μm. In another example, each second depression 30 in the inactive region(s) 14 is separated from another second depression 30 by a pitch ranging from about 350 nm to about 650 nm. The pitch of the second depressions 30 in the inactive region(s) 14 may be tuned to facilitate fluidic pinning within the inactive region(s) 14. While example average pitch values have been provided, it is to be understood that other average pitch values may be used.

The size of each depression 26, 30 may be characterized by its volume, opening area, depth, and/or diameter or length and width. For example, the volume can range from about 1×10⁻³ μm³ to about 100 μm³, e.g., about 1×10⁻² μm³, about 0.1 μm³, about 1 μm³, about 10 μm³, or more, or less. For another example, the opening area can range from about 1×10⁻³ μm² to about 100 μm², e.g., about 1×10⁻² μm², about 0.1 μm², about 1 μm², at least about 10 μm², or more, or less. For still another example, the depth can range from about 0.1 μm to about 100 μm, e.g., about 0.5 μm, about 1 μm, about 10 μm, or more, or less. For another example, the depth can range from about 0.1 μm to about 100 μm, e.g., about 0.5 μm, about 1 μm, about 10 μm, or more, or less. For yet another example, the diameter or each of the length and width can range from about 0.1 μm to about 100 μm, e.g., about 0.5 μm, about 1 μm, about 10 μm, or more, or less. As such, in a specific example, each second depression 30 in the inactive region(s) 14 has a diameter ranging from about 0.1 μm to about 100 μm. It is to be understood that the volume, opening area, depth, and/or diameter or length and width of the depressions 26 in the active region(s) 12 may be the same as or different than, respectively, the volume, opening area, depth, and/or diameter or length and width of the depressions 30 in the inactive region(s) 14.

As mentioned, the first depressions 26 within the active region(s) 12 include surface chemistry, i.e., the polymeric hydrogel 36, which may have the primers 38A, 38B grafted thereto. In at least some examples, the inactive region(s) 14 (and the second depressions 30 defined therein) are free of (i.e., devoid of) surface chemistry and thus do not include the polymeric hydrogel 36 or the primers 38A, 38B.

The polymeric hydrogel 36 disposed within the plurality of first depressions 26 (of the active region(s) 12) may be any gel material that can swell when liquid is taken up and that can contract when liquid is removed, e.g., by drying. In an example, the polymeric hydrogel 36 includes an acrylamide copolymer, such as poly N-(5-azidoacetamidylpentyl) acrylamide-co-acrylamide, hereinafter PAZAM. PAZAM and some other forms of the acrylamide copolymer are represented by the following structure (I):

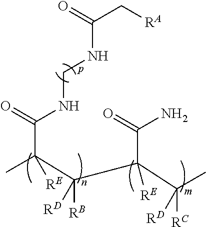

wherein:
R^{A} is selected from the group consisting of azido, optionally substituted amino, optionally substituted alkenyl, optionally substituted alkyne, halogen, optionally substituted hydrazone, optionally substituted hydrazine, carboxyl, hydroxy, optionally substituted tetrazole, optionally substituted tetrazine, nitrile oxide, nitrone, sulfate, and thiol;
R^{B} is H or optionally substituted alkyl;
R^{C}, R^{D}, and R^{E} are each independently selected from the group consisting of H and optionally substituted alkyl;
each of the —(CH₂)ₚ— can be optionally substituted;
p is an integer in the range of 1 to 50;
n is an integer in the range of 1 to 50,000; and
m is an integer in the range of 1 to 100,000.

One of ordinary skill in the art will recognize that the arrangement of the recurring “n” and “m” features in structure (I) are representative, and the monomeric subunits may be present in any order in the polymer structure (e.g., random, block, patterned, or a combination thereof).

The molecular weight of PAZAM and other forms of the acrylamide copolymer may range from about 5 kDa to about 1500 kDa or from about 10 kDa to about 1000 kDa. In a specific example, the molecular weight of the acrylamide copolymer is about 312 kDa.

In some examples, PAZAM and other forms of the acrylamide copolymer are linear polymers. In some other examples, PAZAM and other forms of the acrylamide copolymer are lightly cross-linked polymers.

In other examples, the gel material may be a variation of the structure (I). In one example, the acrylamide unit may be replaced with N, N-dimethylacrylamide

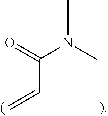

In this example, the acrylamide unit in structure (I) may be replaced with

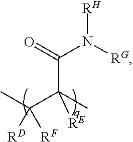

where R^{D}, R^{E}, and R^{F} are each H or a C1-C6 alkyl, and R^{G} and R^{H} are each a C1-C6 alkyl (instead of H as is the case with the acrylamide). In this example, q may be an integer in the range of 1 to 100,000. In another example, the N,N-dimethylacrylamide may be used in addition to the acrylamide unit. In this example, structure (I) may include

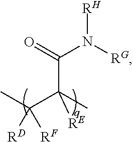

in addition to the recurring “n” and “m” features, where R^{D}, R^{E}, and R^{F} are each H or a C1-C6 alkyl, and R^{G} and R^{H} are each a C1-C6 alkyl. In this example, q may be an integer in the range of 1 to 100,000.

As another example of the polymeric hydrogel 36, the recurring “n” feature in structure (I) may be replaced with a monomer including a heterocyclic azido group having structure (II):

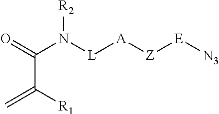

wherein R¹ is H or a C1-C6 alkyl; R₂ is H or a C1-C6 alkyl; L is a linker including a linear chain with 2 to 20 atoms selected from the group consisting of carbon, oxygen, and nitrogen and 10 optional substituents on the carbon and any nitrogen atoms in the chain; E is a linear chain including 1 to 4 atoms selected from the group consisting of carbon, oxygen and nitrogen, and optional substituents on the carbon and any nitrogen atoms in the chain; A is an N substituted amide with an H or a C1-C4 alkyl attached to the N; and Z is a nitrogen containing heterocycle. Examples of Z include 5 to 10 carbon-containing ring members present as a single cyclic structure or a fused structure. Some specific examples of Z include pyrrolidinyl, pyridinyl, or pyrimidinyl.

As still another example, the polymeric hydrogel 36 may include a recurring unit of each of structure (III) and (IV):

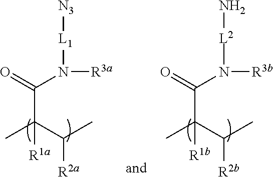

wherein each of R^{1a}, R^{2a}, R^{1b} and R^{2b} is independently selected from hydrogen, an optionally substituted alkyl or optionally substituted phenyl; each of R^{3a} and R^{3b} is independently selected from hydrogen, an optionally substituted alkyl, an optionally substituted phenyl, or an optionally substituted C7-C14 aralkyl; and each of L¹ and L² is independently selected from an optionally substituted alkylene linker or an optionally substituted heteroalkylene linker.

It is to be understood that other polymeric hydrogels 36 may be used, provided that the hydrogels are suitable for grafting oligonucleotide primers 38A, 38B thereto. Some additional examples of suitable materials for the polymeric hydrogel 36 include functionalized polysilanes, such as norbornene silane, azido silane, alkyne functionalized silane, amine functionalized silane, maleimide silane, or any other polysilane having functional groups that can attach the desired primer set 38A, 38B. Other examples of suitable polymeric hydrogels 36 include those having a colloidal structure, such as agarose; or a polymer mesh structure, such as gelatin; or a cross-linked polymer structure, such as polyacrylamide polymers and copolymers, silane free acrylamide (SFA), or an azidolyzed version of SFA. Examples of suitable polyacrylamide polymers may be synthesized from acrylamide and an acrylic acid or an acrylic acid containing a vinyl group, or from monomers that form [2+2]photo-cycloaddition reactions. Still other examples of suitable polymeric hydrogels include mixed copolymers of acrylamides and acrylates. A variety of polymer architectures containing acrylic monomers (e.g., acrylamides, acrylates etc.) may be utilized in the examples disclosed herein, such as branched polymers, including dendrimers, and the like. For example, the monomers (e.g., acrylamide, etc.) may be incorporated, either randomly or in block, into the branches (arms) of a dendrimer.

The polymeric hydrogel 36 may be formed using any suitable copolymerization process and may be deposited using any of the methods disclosed herein. For at least some of the deposition techniques, the polymeric hydrogel 36 may be incorporated into a mixture, e.g., with water or with ethanol and water, and then applied within the plurality of first depressions 26 (within the active region(s) 12).

The attachment of the polymeric hydrogel 36 to the substrate 18 or to the layer 24 of the multi-layer substrate 20 may be through covalent bonding. As described, in some instances, the substrate 18 or the layer 24 may first be activated, e.g., through silanization and/or plasma ashing, to facilitate the attachment of the polymeric hydrogel 36 thereto. Covalent linking is helpful for maintaining the primers 38A, 38B in the active region(s) 12 throughout the lifetime of the flow cell 10 during a variety of uses.

As shown in FIG. 1B and FIG. 1C, the polymeric hydrogel 36 has the primer(s) 38A, 38B attached thereto.

A grafting process may be performed to graft the primers 38A, 38B to the polymeric hydrogel 36 either before or after the polymeric hydrogel 36 is deposited in accordance with the examples set forth herein. When the primers 38A, 38B are attached to the polymeric hydrogel 36 before the hydrogel is deposited, the hydrogel is referred to as being “pre-grafted.”

In an example, the primers 38A, 38B may be amplification primers. In this example, the amplification primers 38A, 38B can be immobilized to the polymeric hydrogel 36 (within the active region(s) 12) by single point covalent attachment at or near 5′ end of the primers 38A, 38B. This attachment leaves (i) an adapter-specific portion of the primers 38A, 38B free to anneal to its cognate sequencing-ready nucleic acid fragment and (ii) the 3′ hydroxyl group free for primer extension. Any suitable covalent attachment may be used for this purpose. Examples of terminated primers that may be used include alkyne terminated primers (e.g., which may attach to an azide surface moiety of the polymeric hydrogel 36), or azide terminated primers (e.g., which may attach to an alkyne surface moiety of the polymeric hydrogel 36), or phospho-thioate terminated primers (e.g., which may attach to a bromine surface moiety of the polymeric hydrogel 36).

The primer set includes two different primers 38A, 38B that are used in sequential paired end sequencing. As examples, the primer set may include P5 and P7 primers, P15 and P7 primers, or any combination of the PA primers, the PB primers, the PC primers, and the PD primers set forth herein. As examples, the primer set may include any two PA, PB, PC, and PD primers, or any combination of one PA primer and one PB, PC, or PD primer, or any combination of one PB primer and one PC or PD primer, or any combination of one PC primer and one PD primer.

Specific examples of suitable primers 38A, 38B include P5 and P7 primers used on the surface of commercial flow cells sold by Illumina Inc. for sequencing on HISEQ™, HISEQX™, MISEQ™, MISEQDX™, MINISEQ™, NEXTSEQ™, NEXTSEQDX™, NOVASEQ™, GENOME ANALYZER™, ISEQ™, and other instrument platforms.

The P5 primer (shown as a cleavable primer due to the cleavable nucleobase uracil or “n”) is:

P5 #1: 5′ → 3′
(SEQ. ID. NO. 1)
AATGATACGGCGACCACCGAGAUCTACAC;
or
P5 #2: 5′ → 3′
(SEQ. ID. NO. 2)
AATGATACGGCGACCACCGAGAnCTACAC

where “n” is alkene-thymidine (i.e., alkene-dT) in the sequence; or

P5 #3: 5′ → 3′
(SEQ. ID. NO. 3)
AATGATACGGCGACCACCGAGAnCTACAC

where “n” is inosine in the sequence.

The P7 primer (shown as cleavable primers) may be any of the following:

P7 #1: 5′ → 3′
(SEQ. ID. NO. 4)
CAAGCAGAAGACGGCATACGAnAT

where “n” is 8-oxoguanine;

P7 #2: 5′ → 3′
(SEQ. ID. NO. 5)
CAAGCAGAAGACGGCATACnAGAT

where “n” is 8-oxoguanine;

P7 #3: 5′ → 3′
(SEQ. ID. NO. 6)
CAAGCAGAAGACGGCATACnAnAT

where each “n” is 8-oxoguanine;

P7 #4: 5′ → 3′
(SEQ. ID. NO. 7)
CAAGCAGAAGACGGCATACGAUAT;
or
P7 #5: 5′ → 3′
(SEQ. ID. NO. 8)
CAAGCAGAAGACGGCATACUAGAT.

The P15 primer (shown as a cleavable primer) is:

P15: 5′ → 3′
(SEQ. ID. NO. 9)
AATGATACGGCGACCACCGAGAnCTACAC

where “n” is allyl-T (a thymine nucleotide analog having an allyl functionality).

The other primers (PA-PD, shown as non-cleavable primers) mentioned above include:

PA 5′ → 3′
(SEQ. ID. NO. 10)
GCTGGCACGTCCGAACGCTTCGTTAATCCGTTGAG
PB 5′ → 3′
(SEQ. ID. NO. 11)
CGTCGTCTGCCATGGCGCTTCGGTGGATATGAACT
PC 5′ → 3′
(SEQ. ID. NO. 12)
ACGGCCGCTAATATCAACGCGTCGAATCCGCAACT
PD 5′ → 3′
(SEQ. ID. NO. 13)
GCCGCGTTACGTTAGCCGGACTATTCGATGCAGC

While not shown in the example sequences for PA-PD, it is to be understood that any of these primers may include a cleavage site, such as uracil, 8-oxoguanine, allyl-T, etc. at any point in the strand.

Each of the primers 38A, 38B disclosed herein may also include a polyT sequence at the 5′ end of the primer sequence. In some examples, the polyT region includes from 2 T bases to 20 T bases. As specific examples, the polyT region may include 3, 4, 5, 6, 7, or 10 T bases.

The 5′ end of each primer 38A, 38B may also include a linker. Any linker that includes a terminal alkyne group or another suitable terminal functional group that can attach to the surface functional groups (e.g., R^{A}) of the polymeric hydrogel 36 may be used. In one example, the primers 38A, 38B are terminated with hexynyl functional groups.

As described, primer grafting may be performed before or after the polymeric hydrogel 36 is applied on the substrate 18, 20. In an example, grafting may involve the high-precision method described herein, flow-through deposition, dunk coating, spray coating, puddle dispensing, or by another suitable method that will attach the primer(s) 38A, 38B to the polymeric hydrogel 36 (e.g., that has been applied in depressions 26 within the active region(s) 12).

Each of these example techniques may utilize a primer solution or mixture, which may include the primer(s) 38A, 38B, water, a buffer, and a catalyst. With any of the grafting methods (e.g., grafting before deposition of the polymeric hydrogel 36 or after deposition of the polymeric hydrogel 36), the primers 38A, 38B react with reactive groups of the polymeric hydrogel 36 during processes of using and/or preparing the active region(s) 12.

In the examples shown in FIG. 1B and FIG. 1C, the flow cell 10 may also include the protective coating 44 applied over at least the active region(s) 12.

The protective coating 44 generally includes an aqueous solution of a water-soluble protective material that is deposited and left wet, or that is deposited and dried (e.g., by warming, heating, evaporation, vacuum exposure, convective drying, or the like). In some examples, the water-soluble protective coating solution includes up to about 15%, or from about 1% to 15%, or from about 1% to 10%, or from about 1% to 5%, or from about 2% to 5%, or from about 4% to 8%, or from about 5% to 7.5%, or about 5%, or about 7.5% (mass to volume), of the water-soluble protective material. In some examples, the water-soluble protective coating solution includes from about 5% to about 7.5%, or about 5%, or about 7.5% (mass to volume) of the water-soluble protective material.

In addition to water, some examples of the water-soluble protective coating solution may include an alcohol co-solvent to increase the drying rate and decrease the surface tension. Other suitable co-solvents may include low volatility solvents, such as glycerol, to slow down evaporation.

In some examples, the protective coating 44 is at least 95% soluble, e.g., in water, such that the protective coating 44 can be readily removed from active regions 12 of the flow cell 10 prior to amplification and clustering. Examples of the water-soluble protective material that may be used to generate this type of protective coating 20 include polyvinyl alcohol, a polyvinyl alcohol/polyethylene glycol graft copolymer (e.g., KOLLICOAT® IR, available from BASF Corp.), sucrose, chitosan, dextran (e.g., molecular weight of 200,000 Da), polyacrylamide (e.g., molecular weight of 40,000 Da, 200,000 Da, etc.), polyethylene glycol, ethylenediaminetetraacetic acid sodium salt (i.e., EDTA), tris(hydroxymethyl)aminomethane with ethylenediaminetetraacetic acid, (tris(2-carboxyethyl) phosphine), tris(3-hydroxypropyltriazolylmethyl)amine, bathophenanthrolinedisulfonic acid disodium salt, hydroxyl functional polymers, glycerol, and saline sodium citrate.

In some instances, the flow cell 10 further includes a complementary metal oxide semiconductor (CMOS) chip 94 coupled to a bottom of the substrate 18, 20 (through the base support 22 or directly to a bottom of the single-layer substrate 18), which forms the flow cell 10′ shown in FIG. 2. For ease of illustration, the single-layer substrate 18 is shown in FIG. 2. It is to be understood, however, that the multi-layer substrate 20 could be used instead.

As shown in FIG. 2, one example of the flow cell 10′ includes the complementary metal oxide semiconductor (CMOS) chip 94. While the flow cell 10′ is shown as the enclosed version with a lid 116 (where the flow channel(s) 11 is/are defined between the lid 116 and the substrate 18, 20), it is to be understood that an open-wafer form of the flow cell 10′ may be attached to the CMOS chip 94 or an enclosed version with a second patterned structure may be attached to the CMOS chip 94. In the open-wafer forms of the flow cell 10′, the flow channel(s) 11 is/are defined by one or more active regions 12 and/or inactive regions 14 of the substrate 18, 20, and no lid or second patterned structure is included.

Similar to the structure of FIG. 1C, the substrate 18 of the flow cell 10′ includes a flow channel 11 in which a single active region 12 (including the plurality of first depressions 26 separated by interstitial regions 28) is flanked by inactive regions 14 at opposite edges 40, 40′, where the inactive regions 14 include the second depressions 30 (separated by interstitial regions 32) and the fluidic pinning region 34. As shown in FIG. 2, the second depressions 30 also include the hydrophobic barrier 42. While not shown in FIG. 2, it is to be understood that the flow cell 10′ may alternatively include a structure similar to that of FIG. 1B, where two different active regions 12 (separated by an inactive region 14) are included in a single flow channel 11. The protective coating 44 may be positioned over at least the active region(s) 12 of the substrate 18, 20 in any example.

In the illustrated example, the substrate 18 of the flow cell 10′ may be affixed directly to, and thus be in physical contact with, the complementary metal oxide semiconductor chip 94 through one or more securing mechanisms (e.g., adhesive, bond, fasteners, and the like). It is to be understood that the substrate 18 may be removably coupled to the complementary metal oxide semiconductor (CMOS) chip 94.

The CMOS chip 94 includes a plurality of stacked layers 96 including, for example, silicon layer(s), dielectric layer(s), metal-dielectric layer(s), metal layer(s), etc.). The stacked layers 96 make up the device circuitry, which includes detection circuitry.

The CMOS chip 94 includes optical components, such as optical sensor(s) 98 and optical waveguide(s) 100. The optical components are arranged such that each optical sensor 98 at least substantially aligns with, and thus is operatively associated with, a single optical waveguide 100 and a single depression 26 of the flow cell 10′. However, in other examples, a single optical sensor 98 may receive photons through more than one optical waveguide 100 and/or from more than one depression 26. In these other examples, the single optical sensor 98 is operatively associated with more than one optical waveguide 100 and/or more than one depression 26.

As used herein, a single optical sensor 98 may be a light sensor that includes one pixel or more than one pixel. As an example, each optical sensor 98 may have a detection area that is less than about 50 μm². As another example, the detection area may be less than about 10 μm². As still another example, the detection area may be less than about 2 μm². In the latter example, the optical sensor 98 may constitute a single pixel. An average read noise of each pixel of the optical sensor 98 may be, for example, less than about 150 electrons. In other examples, the read noise may be less than about 5 electrons. The resolution of the optical sensor(s) 98 may be greater than about 0.5 megapixels (Mpixels). In other examples, the resolution may be greater than about 5 Mpixels, or greater than about 10 Mpixels.

Also as used herein, a single optical waveguide 100 may be a light guide including a cured filter material that (i) filters the excitation light 104 (propagating from an exterior of the flow cell 10′ towards the surface chemistry within the flow cell 10′), and (ii) permits the light emissions (not shown, resulting from reactions at the depressions 26) to propagate therethrough toward corresponding optical sensor(s) 98. In an example, the optical waveguide 100 may be, for example, an organic absorption filter. As a specific example, the organic absorption filter may filter excitation light 104 of about 532 nm wavelength and permit light emissions of about 570 nm or more wavelengths. The optical waveguide 100 may be formed by first forming a guide cavity in a dielectric layer 106, and then filling the guide cavity with a suitable filter material.

The optical waveguide 100 may be configured relative to the dielectric material 106 in order to form a light-guiding structure. For example, the optical waveguide 100 may have a refractive index of about 2.0 so that the light emissions are substantially reflected at an interface between the optical waveguide 100 and the surrounding dielectric material 106. In certain examples, the optical waveguide 100 is selected such that the optical density (OD) or absorbance of the excitation light 104 is at least about 4 OD. More specifically, the filter material may be selected and the optical waveguide 100 may be dimensioned to achieve at least 4 OD. In other examples, the optical waveguide 100 may be configured to achieve at least about 5 OD or at least about 6 OD.

The flow cell 10′ includes the substrate 18, which is positioned over and attached to the complementary metal oxide semiconductor chip 94. In this example, the substrate 18 (or the base support 22 and/or the layer 24 of the multi-layer substrate 20) functions as a passivation layer. At least a portion of the passivating substrate 18 is in contact with a first embedded metal layer 112 of the CMOS chip 94 and also with an input region 110 of the optical waveguide 100. The contact between the passivating substrate 18 and the first embedded metal layer 112 may be direct contact or may be indirect contact through a shield layer 114.

The substrate 18 (which can act as a passivation layer) may provide one level of corrosion protection for the embedded metal layer 112 of the CMOS chip 94 that is closest in proximity to the substrate 18. In this example, the substrate 18 may include a passivation material that is transparent to the light emissions resulting from reactions within the depressions 26 (e.g., visible light), and that is at least initially resistant to the fluidic environment and moisture that may be introduced into or present in the flow channel 11. An at least initially resistant material acts as an etch barrier to high pH reagents (e.g., pH ranging from 8 to 14) and as a moisture barrier. Examples of suitable materials for the substrate 18 of the flow cell 10′ include silicon nitride (Si₃N₄), silicon oxide (SiO₂), tantalum pentoxide (TaO₅), hafnium oxide (HfO₂), boron doped p+ silicon, or the like. The thickness of the substrate 18 may vary depending, in part upon the sensor dimensions. In an example, the thickness of the substrate 18 ranges from about 100 nm to about 500 nm.

As described herein, the substrate 18 includes a plurality of depressions 26 separated by interstitial regions 28 (in the active region(s) 12) and second depressions 30 and the fluidic pinning region 34 (in the inactive region(s) 14). In this particular example, the substrate 18 includes one active region 12 flanked by respective inactive regions 14 at the edges 40, 40′.

The depressions 26 in the active region 12 include surface chemistry (e.g., the polymeric hydrogel 36 and at least one primer 38A, 38B attached thereto). In some instances, a protective coating 44 (formed from the protective coating solution disclosed herein) is positioned over each of the depressions 26.

In the example shown in FIG. 2, the enclosed flow cell 10′ shown also includes a lid 116 that is operatively connected to the substrate 18 to partially define the flow channel 11 between the substrate 18 (and the depressions 26 therein) and the lid 116. The lid 116 may be any material that is transparent to the excitation light 104 that is directed toward the depressions 22. As examples, the lid 116 may include glass (e.g., borosilicate, fused silica, etc.), plastic, etc. A commercially available example of a suitable borosilicate glass is D 263®, available from Schott North America Inc. Commercially available examples of suitable plastic materials, namely cyclo olefin polymers, are the ZEONOR® products available from Zeon Chemicals L.P.

The lid 116 may be physically connected to the substrate 18 through a material that forms the spacer layer 62. In the example shown in FIG. 2, the spacer layer 62 is/are coupled to a portion the surface of the substrate 18 that is part of the bonding region(s) 46. In this example, the inactive region 14 (including the hydrophobic barrier 42) pins any deposited fluids, thus keeping the bonding region(s) 46 free of material and clear for bonding. It is to be understood that in some examples, the inactive regions 14 may be used for bonding.

In some examples, the spacer layer 62 may be positioned over or in the depressions 30 and over all or a portion of the fluidic pinning region 34. The spacer layer 62 also extends between this/these surface(s) and an interior surface of the lid 116. Alternatively, the substrate 18 may include a bonding region 46 next to the second depressions 30 or next to the fluidic pinning region 34 of an active region 12, and the spacer layer 62 may be attached to the bonding region 46. In some examples, the spacer layer 62 and the lid 116 may be integrally formed such that they 62, 116 are a continuous piece of material (e.g., glass or plastic). In these examples, a thin layer of adhesive may be used to attach the integrally formed piece to at least a portion of the inactive region 14 or the bonding region 46. In other examples, the spacer layer 62 and the lid 116 may be separate components that are coupled to each other. In these other examples, the spacer layer 62 may be the same material as, or a different material than the lid 116. In still other examples, the spacer layer 62 includes a curable adhesive layer that bonds the lid 116 to the substrate 18 (at a portion of its surface).

In an example, the lid 116 may be a substantially rectangular block having an at least substantially planar exterior surface 118, and an at least substantially planar interior surface 120 that defines a portion of the flow channel(s) 11. The block may be mounted onto the spacer layer 62. Alternatively, the block may be etched to define the lid 116 and the spacer layer 62 (which functions as (a) sidewall(s)). For example, a recess may be etched into the transparent block. When the etched block is mounted to the substrate 18, the recess may become the flow channel(s) 11.

The lid 116 may include inlet and outlet ports 122, 124 that are configured to fluidically engage other ports (not shown) for directing fluid(s) into the flow channel 11 (e.g., from a reagent cartridge or other fluid storage system component) and out of the flow channel 11 (e.g., to a waste removal system).

In both open and enclosed versions of the flow cell 10′, the flow channel 11 (and the hydrophobic barrier(s) 42 in the inactive region(s) 14) may be sized and shaped to direct a fluid along the depressions 26 within the active region(s) 12. The height of the flow channel 11 and/or other dimensions of the flow channel 11 may be configured to maintain a substantially even flow of the fluid over the depressions 26. The dimensions of the flow channel 11 may also be configured to control bubble formation. In an example, the height of the flow channel 11 may range from about 50 μm to about 400 μm. In another example, the height of the flow channel 11 may range from about 80 μm to about 200 μm. It is to be understood that the height of the flow channel 11 may vary.

Each depression 26 is a localized region in the substrate 18 where a designated reaction may occur.

In an example, each depression 26 is at least substantially aligned with the input region 110 of a single optical waveguide 100. As such, light emissions at the depressions 26 may be directed into the input region 110, through the waveguide 100, and to an associated optical sensor 98. In other examples, one depression 26 may be aligned with several input regions 110 of several optical waveguides 100. In still other examples, several depressions 26 may be aligned with one input region 110 of one optical waveguide 100.

The embedded metal layer 112 may be any suitable CMOS metal, such as aluminum (Al), aluminum chloride (AlCl), tungsten (W), nickel (Ni), or copper (Cu). The embedded metal layer 112 is a functioning part of the CMOS AVdd line, and through the stacked layers 96, is also electrically connected to the optical sensor 98. Thus, the embedded metal layer 112 participates in the detection/sensing operation.

It is to be understood that the other optical sensors 98 and associated components may be configured in an identical or similar manner. It is also to be understood, however, that the CMOS chip 94 may not be manufactured identically or uniformly throughout. Instead, one or more optical sensor 98 and/or associated components may be manufactured differently or have different relationships with respect to one another.

The stacked layer 96 may include interconnected conductive elements (e.g., conductors, traces, vias, interconnects, etc.) that can conduct electrical current. The circuitry may be configured for selectively transmitting data signals that are based on detected photons. The circuitry may also be configured for signal amplification, digitization, storage, and/or processing. The circuitry may collect and analyze the detected light emissions and generate data signals for communicating detection data to a bioassay system. The circuitry may also perform additional analog and/or digital signal processing in the CMOS chip 94.

The CMOS chip 94 may be manufactured using integrated circuit manufacturing processes. The CMOS chip 94 may include multiple layers, such as a sensor base/layer (e.g., a silicon layer or wafer). The sensor base may include the optical sensor 98. When the CMOS chip 94 is fully formed, the optical sensor 98 may be electrically coupled to the rest of the circuitry in the stack layer 96 through gate(s), transistor(s), etc.

As used in reference to FIG. 2, the term “layer” is not limited to a single continuous body of material unless otherwise noted. For example, the sensor base/layer may include multiple sub-layers that are different materials and/or may include coatings, adhesives, and the like. Furthermore, one or more of the layers (or sub-layers) may be modified (e.g., etched, deposited with material, etc.) to provide the features described herein.

The stacked layers 96 also include a plurality of metal-dielectric layers. Each of these layers includes metallic elements (e.g., M1-M5, which may be, for example, W (tungsten), Cu (copper), Al (aluminum), or any other suitable CMOS conductive material) and dielectric material 106 (e.g., SiO₂). Various metallic elements M1-M5 and dielectric materials 106 may be used, such as those suitable for integrated circuit manufacturing.

In the example shown in FIG. 2, each of the plurality of metal-dielectric layers L1-L6 includes both metallic elements M1, M2, M3, M4, M5 and dielectric material 106. In each of the layers L1-L6, the metallic elements M1, M2, M3, M4, M5 are interconnected and are embedded within dielectric material 106. In some of the metal-dielectric layers L1-L6, additional metallic elements may also be included. Some of these additional metallic elements may be used to address individual pixels through a row and column selector. The voltages at these elements may vary and switch between about −1.4 V and about 4.4 V depending upon which pixel the device is reading out.

The configuration of the metallic elements M1, M2, M3, M4, M5 and dielectric layer 106 in FIG. 2 is illustrative of the circuitry, and it is to be understood that other examples may include fewer or additional layers and/or may have different configurations of the metallic elements M1-M5.

In the example shown in FIG. 2, the shield layer 114 is in contact with at least a portion of the substrate 18. The shield layer 114 has an aperture at least partially adjacent to the input region 110 of the optical waveguide 100. This aperture enables the depressions 26 (and at least some of the light emissions therefrom) to be optically connected to the waveguide 100. It is to be understood that the shield layer 114 may have an aperture at least partially adjacent to the input region 110 of each optical waveguide 100. The shield layer 114 may extend continuously between adjacent apertures.

The shield layer 114 may include any material that can block, reflect, and/or significantly attenuate the light signals that are propagating through the flow channel 11 (or through areas of the flow cell 10′ where surface chemistry is positioned). The light signals may be the excitation light 104 and/or the light emissions from the depressions 22. As an example, the shield layer 114 may be tungsten (W).

It is to be understood that the flow cell 10′ may also be used for optical detection.

Various methods of preparing substrates 18, 20 that include the hydrophobic barrier 42 (and, in some instances, the protective coating 44) as part of respective processes of forming flow cells 10 or 10′ will now be described.

### Flow Cell Preparation Methods

An example of a method of preparing a flow cell 10 or 10′ that utilizes fluidic pinning and the hydrophobic barrier 42 is shown in FIG. 3A through FIG. 3E. This example method may be used as part of a process of forming the flow cell 10, 10′ described herein. In specific examples, and as shown in the figures, this method may be used to form a flow channel 11 architecture that is similar to the structure shown in FIG. 1C and FIG. 1E (i.e., an active region 12 with an inactive region 14 on either side). Alternatively, while not explicitly shown in FIG. 3A through FIG. 3E, it is to be understood that this method may be used to form a flow channel 11 architecture that is similar to the structure shown in FIG. 1B and FIG. 1D (i.e., a flow cell 10 including two active regions 12 on either side of an inactive region 14 at edges 40, 40′), while accounting for structural differences in the workflow.

The example method shown in FIG. 3A through FIG. 3E generally involves activating an active region 12 and an inactive region 14 of a substrate 18, 20, wherein the active region 12 includes a plurality of first depressions 26 separated by first interstitial regions 28, and wherein the inactive region 14 includes: a fluidic pinning region 34 that is directly adjacent to the active region 12, and a plurality of second depressions 30 that are separated by second interstitial regions 32, wherein at least some of the plurality of second depressions 30 are directly adjacent to the fluidic pinning region 34 (shown at FIG. 3B); applying a polymeric hydrogel 36 to the active region 12, whereby the polymeric hydrogel 36 at least partially fills the plurality of first depressions 26, becomes pinned within at least a portion of the fluidic pinning region 34, and does not advance into the plurality of second depressions 30 (shown at FIG. 3C); and applying a hydrophobic polymer 48 to at least a portion of the inactive region 14, whereby the hydrophobic polymer 48 at least partially fills the plurality of second depressions 30, thereby forming a hydrophobic barrier 42 in the inactive region 14 (shown at FIG. 3D). In some instances, the method further involves polishing the structure depicted in FIG. 3D (shown at FIG. 3E).

The structure shown in FIG. 3A may include the single-layer substrate 18 or the multi-layer substrate 20 (including the base support 22 and the layer 24) and may be formed using any suitable patterning technique, such as nanoimprint lithography, photolithography, etching, etc. The patterning technique that is used to form the first depressions 26 (separated by the second interstitial regions 28) in the active region 12 and to form the second depressions 30 (separated by the second interstitial regions 32) in the inactive regions 14 will depend, in part, upon the material used for the substrate 18 or the layer 24 of the substrate 20. In a specific example, the substrate 18 or the layer 24 includes a resin material, and the method involves imprinting the resin with a working stamp including a negative replica of the depressions 26, 30 while the resin is soft. The resin may be cured and/or dried, e.g., via exposure to actinic radiation, heat, or other suitable conditions while the working stamp is in place or after the working stamp has been removed. Removal of the working stamp forms the active region 12 including first depressions 26 and also forms the inactive regions 14 including second depressions 30.

As shown in FIG. 3B, the structure of FIG. 3A is activated to include a surface functionality 50 (shown as a layer), which may be, as examples, a hydroxyl functionality, an azide functionality, an amino functionality, a silane functionality, a norbornene functionality, or a functionality including a combination of any of these functional groups. As one example, when the method involves applying an alkyne-inclusive polymeric hydrogel 36 to the substrate 18 or layer 24, the surface functionality 50 may be an azide. As another example, when the method involves applying a thiol-inclusive polymeric hydrogel 36 to the substrate 18 or layer 24, the surface functionality 50 may be norbornene. Other combinations are possible, and it is to be understood that the functional layer 50 may be selected, at least in part, to be chemically reactive with functional groups that are included in the polymeric hydrogel 36 that is to be applied within the active region 12 (to facilitate attachment of the hydrogel 36 to the substrate 18 or layer 24). Activation of the substrate 18 or of the layer 24 may introduce the surface functionality 50 to an entirety of the surface of the substrate 18 or layer 24, or to desired portions of the substrate 18 or layer 24.

In examples, activation of the single-layer substrate 18 or of the layer 24 involves exposing the substrate 18 or the layer 24 to a suitable silane in a suitable solvent (referred to herein as “silanization” of the single-layer substrate 18 or the layer 24 of the multi-layer substrate 20). Silanization involves the application of a silane or silane derivative over the surface of the substrate 18 or the layer 24. Some example silane derivatives include a cycloalkene unsaturated moiety, such as norbornene, a norbornene derivative (e.g., a (hetero) norbornene including an oxygen or nitrogen in place of one of the carbon atoms), transcyclooctene, transcyclooctene derivatives, transcyclopentene, transcycloheptene, trans-cyclononene, bicyclo[3.3.1]non-1-ene, bicyclo[4.3.1]dec-1 (9)-ene, bicyclo[4.2.1]non-1 (8)-ene, and bicyclo[4.2.1]non-1-ene. Any of these cycloalkenes can be substituted, for example, with an R group, such as hydrogen, alkyl, alkenyl, alkynyl, cycloalkyl, cycloalkenyl, cycloalkynyl, aryl, heteroaryl, heteroalicyclyl, aralkyl, or (heteroalicyclyl)alkyl. An example of the norbornene derivative includes [(5-bicyclo [2.2.1]hept-2-enyl)ethyl]trimethoxysilane. Other example silane derivatives include a cycloalkyne unsaturated moiety, such as cyclooctyne, a cyclooctyne derivative, or bicyclononynes (e.g., bicyclo[6.1.0]non-4-yne or derivatives thereof, bicyclo[6.1.0]non-2-yne, or bicyclo[6.1.0]non-3-yne). These cycloalkynes can be substituted with any of the R groups described herein. The method used to apply the silane or silane derivative may vary depending upon the silane or silane derivative that is being used. Examples of suitable silanization methods include vapor deposition (e.g., a YES method), spin coating, or other deposition methods.

In another example, activation of the single-layer substrate 18 or of the layer 24 involves plasma ashing the substrate 18 or the layer 24. Plasma ashing involves the generation of —OH groups at a surface via exposure of the surface to oxygen plasma, where the —OH groups are included as part of the surface functionality 50.

In some examples, the method involves activating the single-layer substrate 18 or the layer 24 by plasma ashing the substrate 18 or layer 24, and by silanizing the substrate 18 or the layer 24.

As shown in FIG. 3C, following activation of the substrate 18 or layer 24, a polymeric hydrogel 36 may then be introduced to the first depressions 26 defined in the active region 12 of the substrate 18 or of the layer 24. In some instances, the polymeric hydrogel 36 is first applied as a polymeric hydrogel mixture 36′, which can be subsequently dried or cured to form the polymeric hydrogel 36. The polymeric hydrogel mixture 36′, when used, may include any of the hydrogel materials disclosed herein. In examples, the polymeric hydrogel mixture 36′ further includes a suitable solvent and a buffer. The polymeric hydrogel 36 or polymeric hydrogel mixture 36′ may be applied such that the polymeric hydrogel 36 (or polymeric hydrogel mixture 36′) becomes applied within the active region 12, without advancing into the second depressions 30 of either of the inactive regions 14. In an example, a high-precision coating process may be used. The polymeric hydrogel 36 may advance into a portion or into an entirety of the fluidic pinning regions 34 during the application of the polymeric hydrogel 36 (or mixture 36′). In examples, the pinning of the polymeric hydrogel mixture 36′ within the active region 12 (and in some instances, the fluidic pinning region 34) is facilitated by differential surface energy that is created between (i) the depressions 26, 30 in the active region 12 and inactive regions 14, and (ii) a respective intervening fluidic pinning region 34.

The polymeric hydrogel 36 may be applied to the active region 12 using any suitable deposition technique disclosed herein and in an amount that is suitable to partially or fully fill the plurality of first depressions 26 in the active region 12.

As will be described in more detail, in some instances, the polymeric hydrogel 36 (or the polymeric hydrogel mixture 36′) includes a plurality of primers 38A, 38B therein. In these instances, the polymeric hydrogel 36 is “pre-grafted” with the primers 38A, 38B. In other instances, such as when post-grafting is performed, the primers 38A, 38B are not included in the polymeric hydrogel 36 or the polymeric hydrogel mixture 36′.

As shown in FIG. 3D, after the polymeric hydrogel 36 has been applied within the active region 12 (and in some instances, within the fluidic pinning regions 34), the method continues by applying the hydrophobic polymer 48 to the inactive regions 14. In an example, a high-precision coating method may be used. As shown in the figure, the hydrophobic polymer 48 at least partially fills the second depressions 30 in the inactive regions 14 and may advance into a portion or an entirety of the fluidic pinning regions 34, but the hydrophobic polymer 48 does not advance into the adjacent active region 12. This is due at least in part to the differential surface energy described herein (i.e., created between the depressions 26, 30 and the fluidic pinning region(s) 34). In an example, the hydrophobic polymer 48 is perfluoro (polytrimethylene) oxide trimethoxy silane (PPFTMS). Following application of the hydrophobic polymer 48, heating or drying of the hydrophobic polymer 48 may be performed. The hydrophobic polymer 48 ultimately forms the hydrophobic barrier 42 in the inactive region(s) 14 (e.g., after the hydrophobic polymer 48 becomes positioned within the depressions 30 and in some instances, after polishing).

The hydrophobic polymer 48 may be deposited in the inactive regions 14 using any suitable deposition technique disclosed herein. The amount of the hydrophobic polymer 48 that is applied to the inactive regions 14 is selected to be suitable for at least partially filling or fully filling the second depressions 30 in the inactive regions 14.

As such, it is to be understood that in the examples shown in FIG. 3A through FIG. 3E (and in some other example methods disclosed herein), the polymeric hydrogel 36 is applied to the active region 12 before the hydrophobic polymer 48 is applied to the inactive region 14.

After the hydrophobic polymer 48 has been applied to the inactive regions 14, the method continues with polishing the structure of FIG. 3D to generate the structure shown in FIG. 3E. As shown in FIG. 3E, the polishing of the substrate 18 or the layer 24 removes at least some of the polymeric hydrogel 36 and/or hydrophobic polymer 48 from the interstitial regions 28, 32 and from the fluidic pinning regions 34. As further shown in FIG. 3E, the polishing leaves the polymeric hydrogel 36 within the depressions 26 (in the active regions 12) and the hydrophobic barrier 42 within the second depressions 30 (in the inactive regions 14) intact. It is to be understood that, depending on the desired height of the hydrophobic barrier 42, polishing may be controlled such that the hydrophobic barrier 42 protrudes from the depressions 32 in the inactive regions 14 or extends over the interstitial regions 32 (e.g., by limiting the polishing that is performed at the inactive regions 14).

The polishing process may be performed with a chemical slurry (including, e.g., an abrasive, a buffer, a chelating agent, a surfactant, and/or a dispersant) that can remove the polymeric hydrogel 36 and/or the hydrophobic polymer 48 from the interstitial regions 28, 32 and from the fluidic pinning regions 34 without deleteriously affecting the underlying substrate 18, 20, the hydrogel 36 within the depressions 26, or the hydrophobic barrier 42 in the depressions 30. Polishing may also be performed with a solution that does not include the abrasive particles. The polishing process may also be performed using polishing head(s)/pad(s) or other polishing tool(s). As an example, the polishing head may be a Strasbaugh ViPRR II polishing head.

While not shown in FIG. 3A through FIG. 3E, the method may further involve grafting a plurality of primers 38A, 38B to the polymeric hydrogel 36 disposed within the depressions 26 of the active region(s) 12.

The primers 38A, 38B may be grafted using any suitable technique. In an example, grafting may involve flow-through deposition, dunk coating, spray coating, puddle dispensing, or by another suitable method that will attach the primer(s) 38A, 38B to the polymeric hydrogel 36 (e.g., that has been applied in depressions 26 within the active region(s) 12). Each of these example techniques may utilize a primer solution or mixture, which may include the primer(s) 38A, 38B, water, a buffer, and a catalyst. With any of the grafting methods, the primers 38A, 38B react with reactive groups of the polymeric hydrogel 36, e.g., via chemical attachment to a functional group included therein.

The primers 38A, 38B may be any suitable pair of primers disclosed herein (e.g., P5 primers, P7 primers, P15 primers, PA-PD primers). As a result of grafting, the primers 38A, 38B will attach, at their 5′ end, to surface functional groups of the polymeric hydrogel 36, and will have no affinity for the exposed surfaces of the substrate 18 or layer 24 (e.g., the fluidic pinning regions 34 or the interstitial regions 28, 32) or for the hydrophobic barrier 42 within the depressions 30.

In some instances, the primers 38A, 38B are pre-grafted to the polymeric hydrogel 36, and thus the primers 38A, 38B are attached to the polymeric hydrogel 36 (or are included in the polymeric hydrogel mixture 36′) before the hydrogel 36 (or hydrogel mixture 36′) is applied over the substrate 18, 20. In these instances, additional primer grafting is not performed.

It is to be understood that some examples of the method shown in FIG. 3A through FIG. 3E are implemented using the single active region 12 with an inactive region 14 on either side, i.e., at opposite edges 40, 40′ (to generate a structure similar to that of FIG. 1C or FIG. 1E). However, as described, in other examples, the method is implemented using two active regions 12 that are respectively positioned on either side of a single inactive region 14, where the single inactive region 14 prevents materials in one of the active regions 12 from mixing with materials in the other of the active regions 12 (similar to the structure of FIG. 1B and FIG. 1D). In these examples, the method is performed in the same manner as described in reference to examples that include two active regions 12 and a single inactive region 14, while accounting for the structural differences (in terms of the placement of the active regions 12 and the inactive region 14 and the corresponding deposition of the polymeric hydrogel 36 or mixture 36′ and the hydrophobic polymer 48).

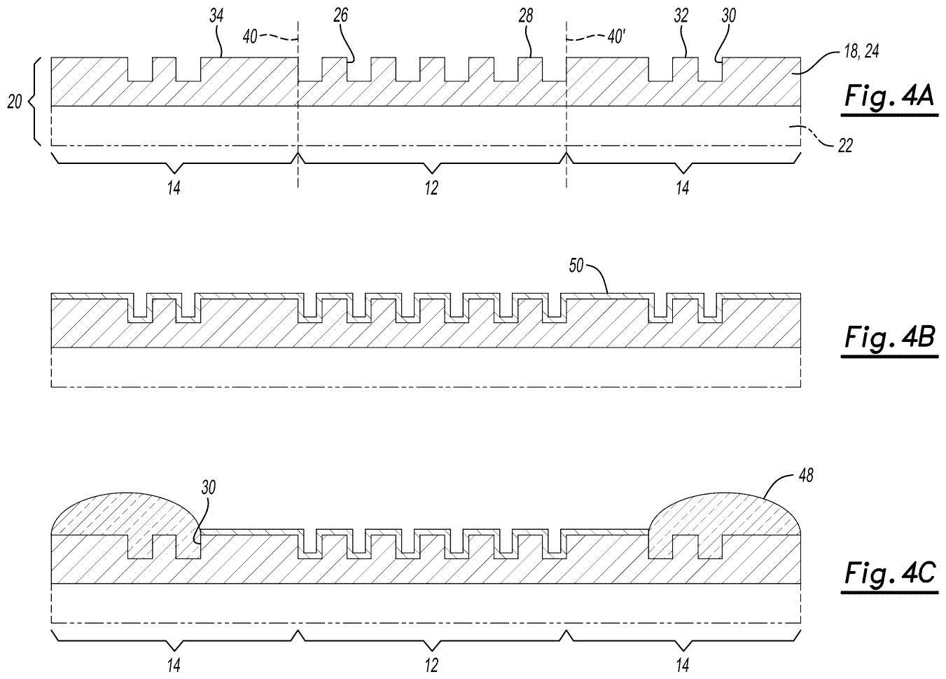

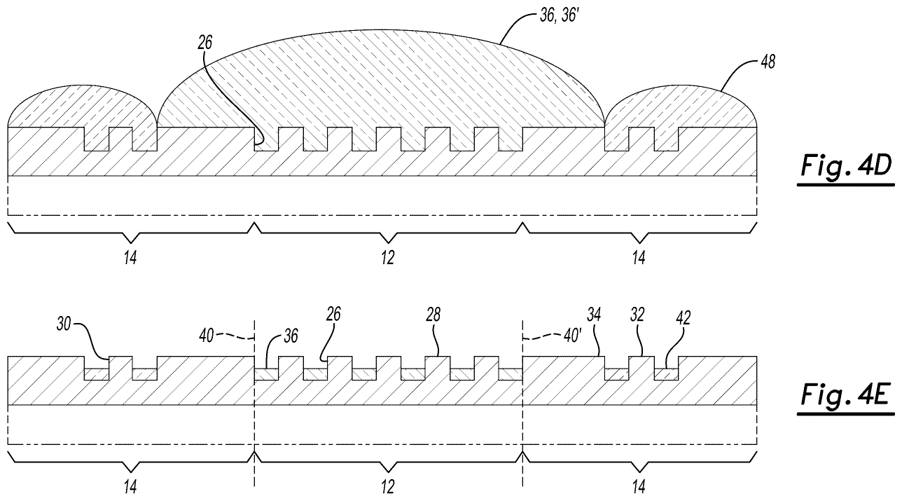

Another example of a method of preparing a flow cell 10 or 10′ that utilizes fluidic pinning and the hydrophobic barrier 42 is shown in FIG. 4A through FIG. 4E. This example method may be used as part of a process of forming the flow cell 10, 10′ described herein.

The structure shown in FIG. 4A may include the single-layer substrate 18 or the multi-layer substrate 20 (including the base support 22 and the layer 24) and may be formed using any suitable patterning technique, such as nanoimprint lithography, photolithography, etching, etc. The patterning technique that is used to form the first depressions 26 (separated by the second interstitial regions 28) in the active region 12 and to form the second depressions 30 (separated by the second interstitial regions 32) in the inactive regions 14 will depend, in part, upon the material used for the substrate 18 or the layer 24 of the substrate 20. The structure shown in FIG. 4A may be generated in a manner similar to the technique described herein in reference to the structure of FIG. 3A (e.g., using a working stamp).

As shown in FIG. 4B, the structure of FIG. 4A may be activated to include a surface functionality 50 (shown as a layer), which may be, as examples, a hydroxyl functionality, an azide functionality, an amino functionality, a silane functionality, a norbornene functionality, or a functionality including a combination of any of these functional groups. Activation of the substrate 18 or of the layer 24 may introduce the surface functionality 50 to an entirety or to a portion of the surface of the substrate 18 or layer 24. Activation of the substrate 18 or the layer 24 may involve silanization and/or plasma ashing, as described in reference to the activation of the structure of FIG. 3B.

As shown in FIG. 4C, following activation of the substrate 18 or layer 24, the hydrophobic polymer 48 is applied to the inactive region(s) 14. In an example, a high-precision coating method may be used. As shown in the figure, the hydrophobic polymer 48 at least partially fills the second depressions 30 in the inactive regions 14 and may advance into a portion or an entirety of the fluidic pinning regions 34, but the hydrophobic polymer 48 does not advance into the adjacent central active region 12, due at least in part to the differential surface energy described herein. In an example, the hydrophobic polymer 48 is perfluoro (polytrimethylene) oxide trimethoxy silane (PPFTMS). In some instances, following application of the hydrophobic polymer 48, heating or drying of the hydrophobic polymer 48 may be performed. The hydrophobic polymer 48 ultimately forms the hydrophobic barrier 42 in the inactive regions 14.

The hydrophobic polymer 48 may be deposited in the inactive regions 14 using any suitable selective deposition technique disclosed herein, such as a high-precision coating method. The amount of the hydrophobic polymer 48 that is applied to the inactive regions 14 is selected to be suitable for at least partially filling or fully filling the second depressions 30 in the inactive regions 14.

As shown in FIG. 4D, the polymeric hydrogel 36 may then be introduced to the first depressions 26 defined in the active region 12 of the substrate 18 or of the layer 24. In some instances, the polymeric hydrogel 36 is first applied as a polymeric hydrogel mixture 36′, which can be subsequently dried or cured to form the polymeric hydrogel 36. The polymeric hydrogel mixture 36′, when used, may include any of the hydrogel materials disclosed herein. In examples, the polymeric hydrogel mixture 36′ further includes a suitable solvent and a buffer. The polymeric hydrogel 36 or polymeric hydrogel mixture 36′ may be applied such that the polymeric hydrogel 36 (or polymeric hydrogel mixture 36′) becomes applied within the active region(s) 12 (and in an entirety or a portion of the fluidic pinning regions 34), without advancing into the second depressions 30 of the inactive regions 14. In examples, the pinning of the polymeric hydrogel 36 within the active region 12 is facilitated by differential surface energy that is created between (i) the respective depressions 26, 30 in the active region 12 and in the inactive regions 14, and (ii) an intervening fluidic pinning region 34 between the active region 12 and one of the inactive regions 14.

The polymeric hydrogel 36 may be applied to the active region 12 using any suitable selective deposition technique disclosed herein and in an amount that is suitable to partially or fully fill the plurality of first depressions 26 in the active region 12.

As such, in the examples shown in FIG. 4A through FIG. 4E, the polymeric hydrogel 36 is applied to the active region 12 after the hydrophobic barrier 42 is formed in the inactive regions 14.

After the polymeric hydrogel 36 has been applied to the active region 12, the method continues with polishing the structure of FIG. 4D to generate the structure shown in FIG. 4E. As shown in FIG. 4E, the polishing of the substrate 18 or the layer 24 removes any polymeric hydrogel 36 and/or hydrophobic polymer 48 from the interstitial regions 28, 32 and from the fluidic pinning regions 34. As further shown in FIG. 4E, the polishing leaves the polymeric hydrogel 36 within the depressions 26 (in the active region 12) and the hydrophobic barrier 42 within the second depressions 30 (in the inactive regions 14) intact.

The polishing process may be performed in a manner similar to that described herein in reference to FIG. 3E. It is to be understood that, depending on the desired height of the hydrophobic barrier 42, polishing may be controlled such that the hydrophobic barrier 42 protrudes from the depressions 32 in the inactive regions 14 or overlies the interstitial regions 32 (e.g., by limiting the polishing that is performed at the inactive regions 14).

While not shown in FIG. 4A through FIG. 4E, the method may further involve grafting a plurality of primers 38A, 38B to the polymeric hydrogel 36 disposed within the depressions 26 of the active region 12.

The primers 38A, 38B may be grafted using any suitable technique disclosed herein. Regardless of the particular grafting method that is used, the primers 38A, 38B react with reactive groups of the polymeric hydrogel 36, e.g., via chemical attachment to a functional group included therein.

The primers 38A, 38B may be any suitable pair of primers disclosed herein (e.g., P5 primers, P7 primers, P15 primers, PA-PD primers). As a result of grafting, the primers 38A, 38B will attach, at their 5′ end, to surface functional groups of the polymeric hydrogel 36, and will have no affinity for the exposed surfaces of the substrate 18 or layer 24 (e.g., the hydrophobic barrier 42, the fluidic pinning regions 34, or the interstitial regions 28, 32).

In some instances, the primers 38A, 38B are pre-grafted to the polymeric hydrogel 36, and thus the primers 38A, 38B are attached to the polymeric hydrogel 36 (or are included in the polymeric hydrogel mixture 36′) before the hydrogel 36 (or hydrogel mixture 36′) is applied over the substrate 18, 20. In these instances, additional primer grafting is not performed.

It is to be understood that some examples of the method shown in FIG. 4A through FIG. 4E are implemented using the single active region 12 with an inactive region 14 on either side, i.e., at opposite edges 40, 40′ (similar to the structure of FIG. 1C and FIG. 1E). However, in other examples, the method is implemented using two active regions 12 on either side of a single inactive region 14, where the single inactive region 14 prevents materials in one of the active regions 12 from mixing with materials in the other of the active regions 12 (similar to the structure of FIG. 1B and FIG. 1D). In these examples, the method is performed in the same manner as described in reference to examples that include two active regions 12 and a single inactive region 14, while accounting for the structural differences (in terms of the placement of the active regions 12 and the inactive region 14 and the corresponding deposition of the polymeric hydrogel 36 or mixture 36′ and the hydrophobic polymer 48).

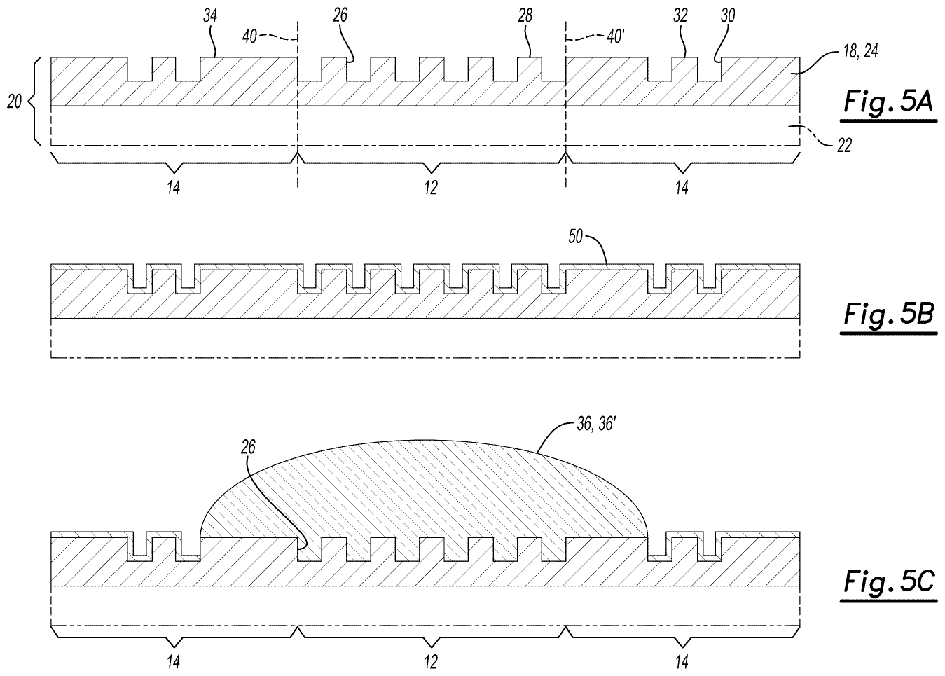

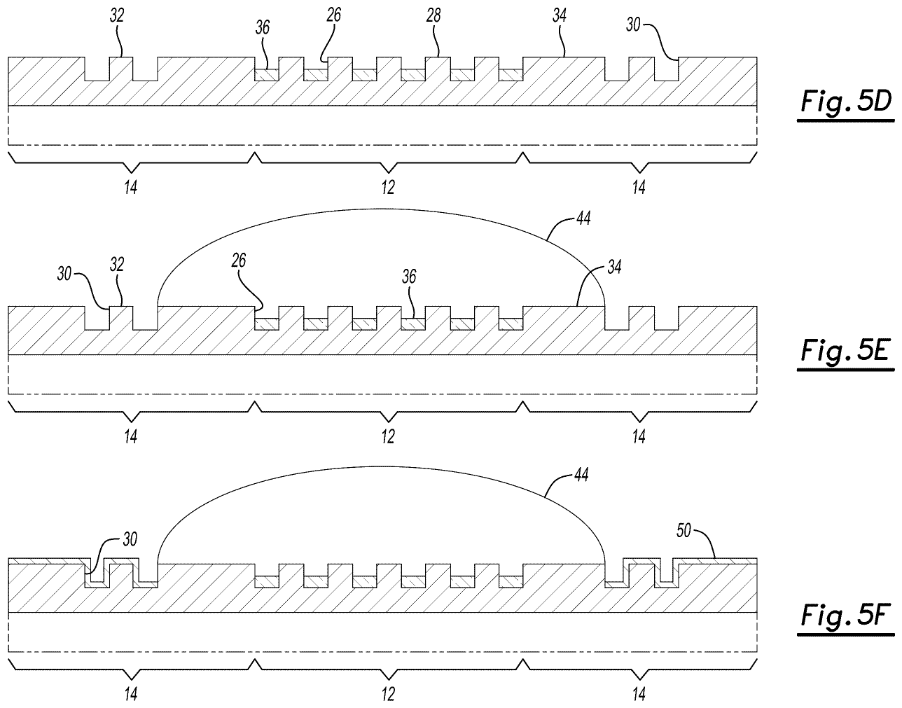

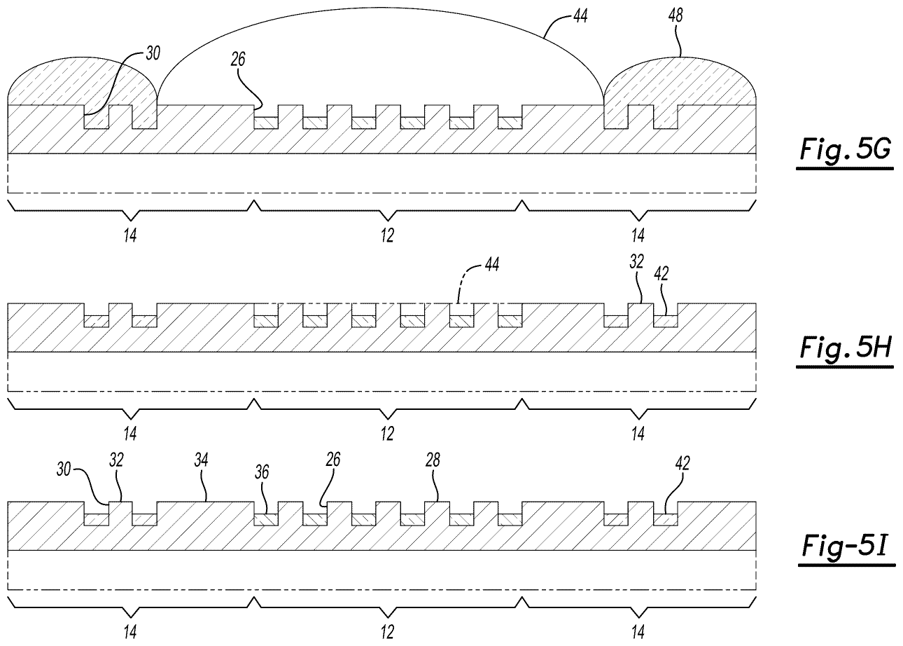

Still another example of a method of preparing a flow cell 10 or 10′ that utilizes fluidic pinning and the hydrophobic barrier 42 is shown in FIG. 5A through FIG. 5I. This example method may be used as part of a process of forming the flow cell 10, 10′ described herein.

The structure shown in FIG. 5A may include the single-layer substrate 18 or the multi-layer substrate 20 (including the base support 22 and the layer 24) and may be formed using any suitable patterning technique, such as nanoimprint lithography, photolithography, etching, etc. The patterning technique that is used to form the first depressions 26 (separated by the second interstitial regions 28) in the active region 12 and to form the second depressions 30 (separated by the second interstitial regions 32) in the inactive regions 14 will depend, in part, upon the material used for the substrate 18 or the layer 24 of the substrate 20. The structure shown in FIG. 5A may be generated in a manner similar to the technique described herein in reference to the structure of FIG. 3A (e.g., using a working stamp).

As shown in FIG. 5B, the structure of FIG. 5A may be activated to include a surface functionality 50 (shown as a layer in the figures), which may be, as examples, a hydroxyl functionality, an azide functionality, an amino functionality, a silane functionality, a norbornene functionality, or a functionality including a combination of any of these functional groups. Activation of the substrate 18 or of the layer 24 may introduce the surface functionality 50 to an entirety of the surface of the substrate 18 or layer 24, or activation may introduce the surface functionality 50 to the active region 12 and not to the inactive regions 14. Activation of the substrate 18 or the layer 24 may involve silanization and/or plasma ashing, as described in reference to the activation of the structure of FIG. 3B.

As shown in FIG. 5C, following activation of the substrate 18 or layer 24, the polymeric hydrogel 36 may then be introduced to the first depressions 26 defined in the active region 12 of the substrate 18 or of the layer 24. In some instances, the polymeric hydrogel 36 is first applied as a polymeric hydrogel mixture 36′, which can be subsequently dried or cured to form the polymeric hydrogel 36. The polymeric hydrogel mixture 36′, when used, may include any of the hydrogel materials disclosed herein. The polymeric hydrogel 36 or polymeric hydrogel mixture 36′ may be applied such that the polymeric hydrogel 36 (or polymeric hydrogel mixture 36′) becomes applied within the active region 12 and in some instances, within a portion or an entirety of the fluidic pinning regions 34, without advancing into the second depressions 30 of the inactive regions 14. In examples, the pinning of the polymeric hydrogel solution 36′ within the active region 12 (and/or the fluidic pinning regions 34) is facilitated by differential surface energy that is created between (i) the respective depressions 26, 30 in the active region 12 and inactive regions 14, and (ii) an intervening fluidic pinning region 34.

The polymeric hydrogel 36 may be applied to the active region 12 using any suitable selective deposition technique disclosed herein and in an amount that is suitable to partially or fully fill the plurality of first depressions 26 in the active region 12.

As shown in FIG. 5D, following the application of the polymeric hydrogel 36, polishing may then be performed to remove the polymeric hydrogel 36 from the interstitial regions 28 separating the first depressions 26, and from the fluidic pinning regions 34. Polishing may be performed using a suitable technique described herein. Polishing leaves the polymeric hydrogel 36 within the plurality of first depressions 26 intact.

As shown in FIG. 5E, a protective coating 44 may then be selectively applied/deposited to the active region(s) 12, such that the protective coating 44 covers the plurality of first depressions 26 defined in the active region(s) 12. In some instances, the protective coating 44 may advance into a portion or an entirety of the fluidic pinning regions 34, but the protective coating 44 does not advance into the second depressions 30 of the inactive regions 14. The protective coating 44 may first be applied as a protective coating mixture, which can be subsequently dried or cured to form the protective coating 44.

The protective coating mixture, when used, includes an aqueous solution of a water-soluble protective material that is deposited and left wet, or that is deposited and dried (e.g., by warming, heating, evaporation, vacuum exposure, convective drying, or the like). In some examples, the protective coating mixture includes up to about 15%, or from about 1% to 15%, or from about 1% to 10%, or from about 1% to 5%, or from about 2% to 5%, or from about 4% to 8%, or from about 5% to 7.5%, or about 5%, or about 7.5% (mass to volume), of the water-soluble protective material. In some examples, the protective coating mixture includes from about 5% to about 7.5%, or about 5%, or about 7.5% (mass to volume) of the water-soluble protective material.

In addition to water, some examples of the protective coating mixture may include an alcohol co-solvent to increase the drying rate and decrease the surface tension. Other suitable co-solvents may include low volatility solvents, such as glycerol, to slow down evaporation.

In some examples, the protective coating 44 is at least 95% soluble, e.g., in water, such that the protective coating 44 can be readily removed from the active region 12 of the flow cell 10, 10′ prior to amplification and clustering. Examples of the water-soluble protective material that may be used to generate this type of protective coating 44 include polyvinyl alcohol, a polyvinyl alcohol/polyethylene glycol graft copolymer (e.g., KOLLICOAT® IR, available from BASF Corp.), sucrose, chitosan, dextran (e.g., molecular weight of 200,000 Da), polyacrylamide (e.g., molecular weight of 40,000 Da, 200,000 Da, etc.), polyethylene glycol, ethylenediaminetetraacetic acid sodium salt (i.e., EDTA), tris(hydroxymethyl)aminomethane with ethylenediaminetetraacetic acid, (tris(2-carboxyethyl) phosphine), tris(3-hydroxypropyltriazolylmethyl)amine, bathophenanthrolinedisulfonic acid disodium salt, hydroxyl functional polymers, glycerol, and saline sodium citrate.

As shown in FIG. 5F, following the application of the protective coating 44 (or the protective coating mixture that forms the coating 44), activation of the inactive regions 14 is performed. Activation of the inactive regions 14 may be performed in a manner similar to that described in reference to FIG. 3B. Activation of the inactive regions 14 generates the surface functionality 50 at the inactive regions 14, which may be any example surface functionality 50 disclosed herein.

As shown in FIG. 5G, the hydrophobic polymer 48 is then applied to the inactive regions 14. As shown in the figure, the hydrophobic polymer 48 at least partially fills the second depressions 30 in the inactive regions 14 and may advance into a portion or an entirety of the fluidic pinning regions 34, but the hydrophobic polymer 48 does not advance into the active region 12, due at least in part to the presence of the protective coating 44 in the active region 12, alone or in combination with the differential surface energy described herein. In an example, the hydrophobic polymer 48 is perfluoro (polytrimethylene) oxide trimethoxy silane (PPFTMS). In some instances, following application of the hydrophobic polymer 48, heating or drying of the hydrophobic polymer 48 may be performed. The hydrophobic polymer 48 ultimately forms the hydrophobic barrier 42 in the depressions 30 defined in the inactive regions 14.

The hydrophobic polymer 48 may be deposited in the inactive regions 14 using any suitable deposition technique disclosed herein. The amount of the hydrophobic polymer 48 that is applied to the inactive regions 14 is selected to be suitable for at least partially filling or fully filling the second depressions 30 in the inactive regions 14.

The attachment of the hydrophobic polymer 48 to the activated surfaces of the substrate 18, 20 at the inactive regions 14 is facilitated by a chemical interaction between the surface functionality 50 and functional groups of the hydrophobic polymer 48. It is to be understood that, due in part to the presence of the protective coating 44, the hydrophobic polymer 48 does not become applied within the active region(s) 12. In other words, in these example methods, the protective coating 44 prevents the hydrophobic polymer 48 from being applied within the active region 12 during the applying of the hydrophobic polymer 48.

As such, it is to be understood that in the examples shown in FIG. 5A through FIG. 5I, after the polymeric hydrogel 36 is applied to the active region 12 and before the hydrophobic polymer 48 is applied to at least a portion of the inactive regions 14, the method further comprises applying a protective coating 44 to the active region 12, whereby the protective coating 44 covers and passivates the polymeric hydrogel 36.

While not shown in FIG. 5G, in some instances, the protective coating 44 is removed from the active region(s) 12 after the hydrophobic polymer 48 is applied within the inactive region(s) 14. Removal of the protective coating 44 may involve exposing the protective coating 44 to a suitable aqueous solvent, such as water.

After hydrophobic polymer 48 has been applied within the inactive regions 14 (and in some instances, after the protective coating 44 has been removed), any excess hydrophobic polymer 48 may be removed from the interstitial regions 32 and from the fluidic pinning region(s) 34, e.g., using a suitable polishing process disclosed herein. This is shown in FIG. 5H. As shown, the polishing of the substrate 18 or the layer 24 forms the hydrophobic barrier 42 within the second depressions 30 of the inactive regions 14. As further shown in FIG. 5H, the polishing leaves the polymeric hydrogel 36 (and in some instances, the protective coating 44) within the depressions 26 and the hydrophobic barrier 42 within the second depressions 30 intact. It is to be understood that, depending on the desired height of the hydrophobic barrier 42, polishing may be controlled such that the hydrophobic barrier 42 protrudes from the depressions 30 in the inactive regions 14 (e.g., by limiting the polishing that is performed at the inactive regions 14) or extends over the interstitial regions 32.

In examples in which the protective coating 44 has not yet been removed (e.g., via dissolution or the polishing process), removal of the protective coating 44 may then be performed, as shown in FIG. 5I (e.g., via exposure to a suitable solvent disclosed herein).

In some of these examples, such as when a non-pre-grafted polymeric hydrogel 36 is applied to the active region(s) 12, the method proceeds by grafting primers 38A, 38B to the polymeric hydrogel 36 within the first depressions 26.

The primers 38A, 38B may be grafted using any suitable technique disclosed herein. Regardless of the particular grafting method that is used, the primers 38A, 38B react with reactive groups of the polymeric hydrogel 36, e.g., via chemical attachment to a functional group included therein.

The primers 38A, 38B may be any suitable pair of primers disclosed herein (e.g., P5 primers, P7 primers, P15 primers, PA-PD primers). As a result of grafting, the primers 38A, 38B will attach, at their 5′ end, to surface functional groups of the polymeric hydrogel 36, and will have no affinity for the exposed surfaces of the substrate 18 or layer 24 (e.g., the fluidic pinning region(s) 34 or the interstitial regions 28, 32) or for the hydrophobic barrier 42.

In some instances, the primers 38A, 38B are pre-grafted to the polymeric hydrogel 36, and thus the primers 38A, 38B are attached to the polymeric hydrogel 36 (or are included in the polymeric hydrogel mixture 36′) before the hydrogel 36 (or hydrogel mixture 36′) is applied over the substrate 18, 20. In these instances, additional primer grafting is not performed, and removal of the protective coating 44 exposes the polymeric hydrogel 36, which is pre-grafted with the primers 38A, 38B.

It is to be understood that some examples of the method shown in FIG. 5A through FIG. 5I are implemented using the single active region 12 with an inactive region 14 on either side, i.e., at opposite edges 40, 40′ (similar to the structure of FIG. 1C and FIG. 1E). However, in other examples, the method is implemented using two separate, discrete active regions 12 on either side of a single inactive region 14, where the single inactive region 14 prevents materials in one of the active regions 12 from mixing with materials in the other of the active regions 12 (similar to the structure of FIG. 1B and FIG. 1D). In these examples, the method is performed in the same manner as described in reference to examples that include two active regions 12 and a single inactive region 14, while accounting for the structural differences (in terms of the placement of the active regions 12 and the inactive region 14 and the corresponding deposition of the polymeric hydrogel 36 or mixture 36′ and the hydrophobic polymer 48).

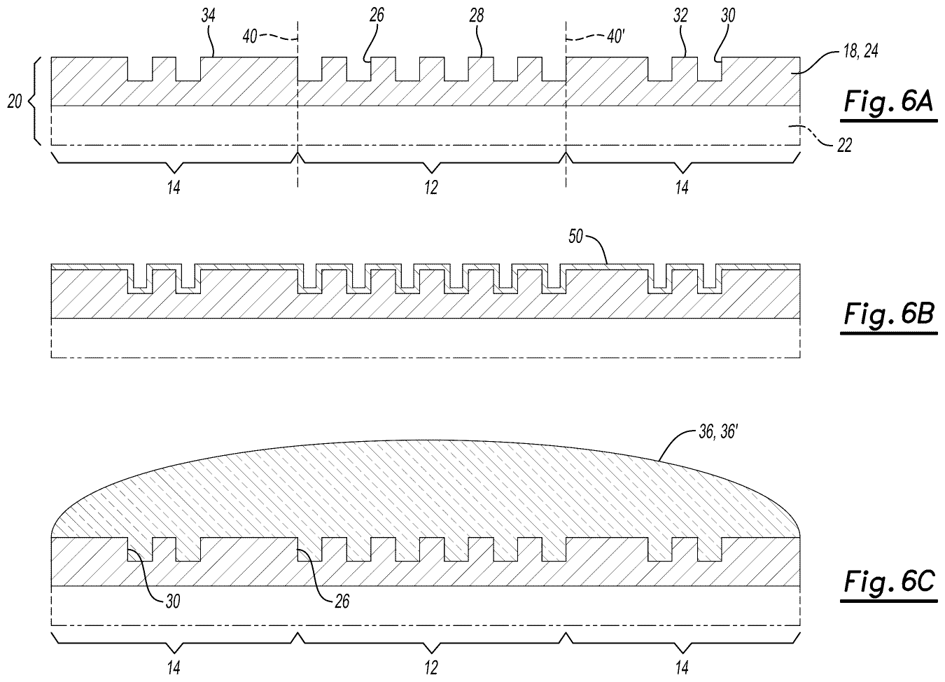

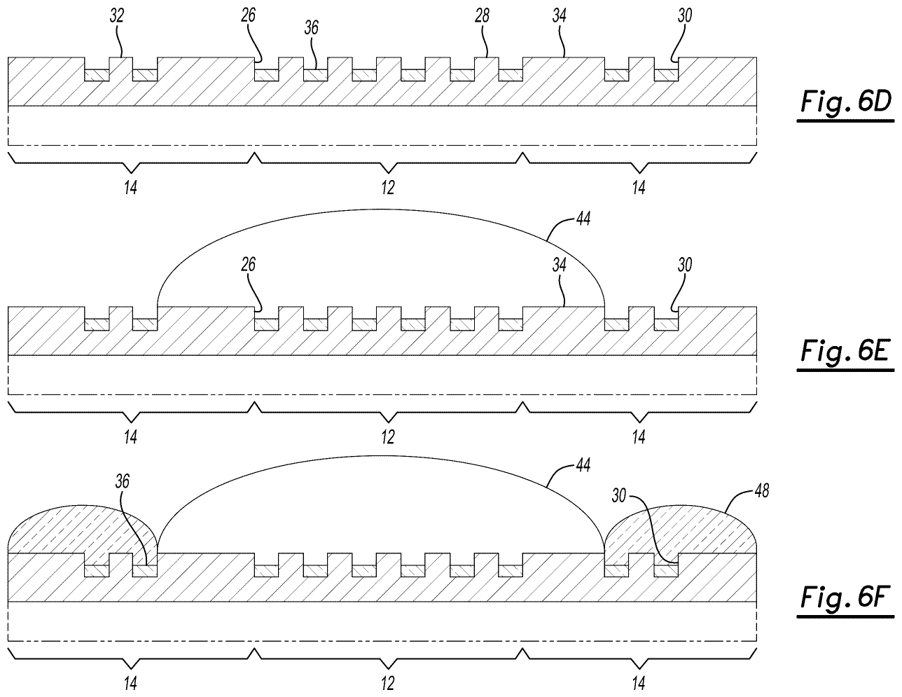

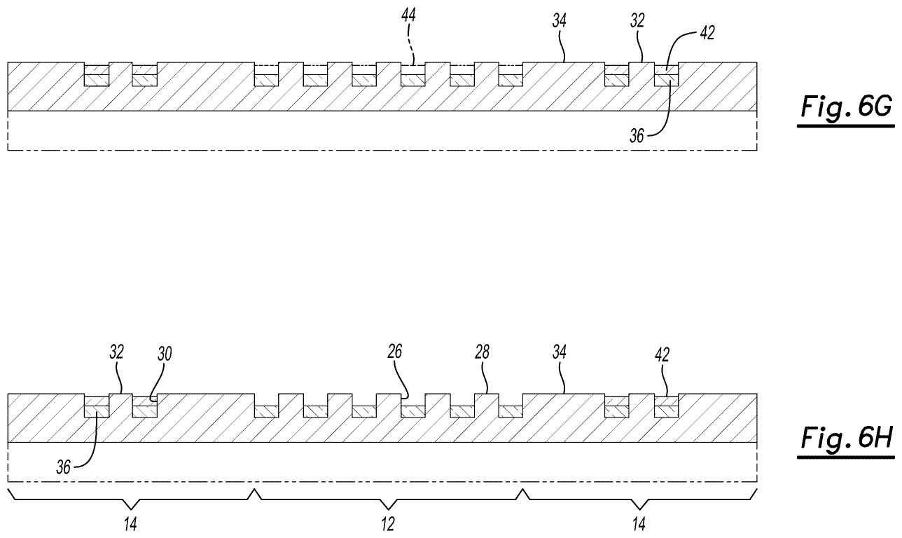

Yet another example of a method of preparing a flow cell 10 or 10′ that utilizes fluidic pinning and the hydrophobic barrier 42 is shown in FIG. 6A through FIG. 6H. This example method may be used as part of a process of forming the flow cell 10, 10′ described herein.

The example method shown in FIG. 6A through FIG. 6H generally involves: activating an active region 12 and an inactive region 14 of a substrate 18, 20, wherein the active region 12 includes a plurality of first depressions 26 separated by first interstitial regions 28, and wherein the inactive region 14 includes: a fluidic pinning region 34 that is directly adjacent to the active region 12, and a plurality of second depressions 30 that are separated by second interstitial regions 32, wherein at least some of the plurality of second depressions 30 are directly adjacent to the fluidic pinning region 34 (shown at FIG. 6B); applying a polymeric hydrogel 36 to the active region 12 and to the inactive region 14, whereby the polymeric hydrogel 36 at least partially fills the plurality of first depressions 26 and at least partially fills the plurality of second depressions 30 (shown at FIG. 6C); applying a protective coating 44 to the active region 12, whereby the protective coating 44 covers and passivates the polymeric hydrogel 36 that at least partially fills the plurality of first depressions 26 (shown at FIG. 6E); and applying a hydrophobic polymer 48 to the inactive region 14, whereby the hydrophobic polymer 48 at least partially fills the plurality of second depressions 30 and attaches to the polymeric hydrogel 36 therein, thereby forming a hydrophobic barrier 42 in the inactive region 14 (shown at FIG. 6F through FIG. 6H).

The structure shown in FIG. 6A may include the single-layer substrate 18 or the multi-layer substrate 20 (including the base support 22 and the layer 24) and may be formed using any suitable patterning technique, such as nanoimprint lithography, photolithography, etching, etc. The patterning technique that is used to form the first depressions 26 (separated by the second interstitial regions 28) in the active region 12 and to form the second depressions 30 (separated by the second interstitial regions 32) in the inactive regions 14 will depend, in part, upon the material used for the single-layer substrate 18 or the layer 24 of the multi-layer substrate 20. The structure shown in FIG. 6A may be generated in a manner similar to the technique described herein in reference to the structure of FIG. 3A (e.g., using a working stamp).

As shown in FIG. 6B, the structure of FIG. 6A may activated to include a surface functionality 50 (shown as a layer), which may be, as examples, a hydroxyl functionality, an azide functionality, an amino functionality, a silane functionality, a norbornene functionality, or a functionality including a combination of any of these functional groups. Activation of the substrate 18 or of the layer 24 may introduce the surface functionality 50 to an entirety of the surface of the substrate 18 or layer 24, or activation may introduce the surface functionality 50 to the active region 12 and not to the inactive regions 14. Activation of the substrate 18 or the layer 24 may involve silanization and/or plasma ashing, as described in reference to the activation of the structure of FIG. 3B.

As shown in FIG. 6C, following activation of the substrate 18 or layer 24, the polymeric hydrogel 36 may then be introduced to an entirety of the substrate 18 or layer 24, such that the polymeric hydrogel 36 at least partially fills the plurality of first depressions 26 defined in the active region 12, covers the fluidic pinning regions 34 and the interstitial regions 28, 32, and at least partially fills the plurality of second depressions 30 defined in the inactive regions 14. In some instances, the polymeric hydrogel 36 is first applied as a polymeric hydrogel mixture 36′, which can be subsequently dried or cured to form the polymeric hydrogel 36. The polymeric hydrogel mixture 36′, when used, may include any of the hydrogel materials disclosed herein.

The polymeric hydrogel 36 may be applied to the active region 12 and the inactive regions 14 using any suitable deposition technique disclosed herein and in an amount that is suitable to partially or fully fill (i) the plurality of first depressions 26 in the active region 12 and (ii) the plurality of second depressions 30 in the inactive regions 14.

As shown in FIG. 6D, following the application of the polymeric hydrogel 36, polishing may then be performed to remove the polymeric hydrogel 36 from the interstitial regions 28, 32 separating the respective depressions 26, 30, and to remove the polymeric hydrogel 36 from the fluidic pinning regions 34. Polishing may be performed using a suitable technique described herein. Polishing leaves the polymeric hydrogel 36 within the plurality of first depressions 26 and within the plurality of second depressions 30 intact.

As shown in FIG. 6E, the protective coating 44 may then be selectively applied/deposited to the active region 12, such that the protective coating 44 covers the plurality of first depressions 26 defined in the active region 12. In some instances, the protective coating 44 also covers a portion or an entirety of the fluidic pinning regions 34, but the protective coating 44 does not advance beyond the fluidic pinning regions 34 (and thus does not advance into the depressions 30 of the inactive regions 14). The protective coating 44 may first be applied as a protective coating mixture, which can be subsequently dried or cured to form the protective coating 44, and the mixture may include any of the suitable materials disclosed herein (and in any suitable respective amounts).

As shown in FIG. 6F, following the application of the protective coating 44 (or the protective coating mixture that forms the coating 44), the hydrophobic polymer 48 is then applied to the inactive regions 14. As shown in the figure, the hydrophobic polymer 48 at least partially fills the second depressions 30 in the inactive regions 14 and the hydrophobic polymer 48 may advance into a portion or an entirety of the fluidic pinning regions 34, but the hydrophobic polymer 48 does not advance into the active region 12, due at least in part to the presence of the protective coating 44. As such, in examples, during the applying of the hydrophobic polymer 36, the protective coating 44 prevents the hydrophobic polymer 48 from being applied within the active region 12.

In an example, the hydrophobic polymer 48 is perfluoro (polytrimethylene) oxide trimethoxy silane (PPFTMS). It is understood, however, that the hydrophobic polymer 48 may be any suitable hydrophobic polymer 48 example disclosed herein.

In some instances, following application of the hydrophobic polymer 48, heating or drying of the hydrophobic polymer 48 may be performed. The hydrophobic polymer 48 ultimately forms the hydrophobic barrier 42 in the inactive regions 14.

The positioning of the hydrophobic polymer 48 within the second depressions 30 may be facilitated by chemical attachment of the hydrophobic polymer 48 to the polymeric hydrogel 36 disposed within the second depressions 30. As an example, the polymeric hydrogel 36 may include azide groups, and the hydrophobic polymer 48 may include a functional group that is chemically reactive therewith, such as an alkyne.

The hydrophobic polymer 48 may be deposited in the inactive regions 14 using any suitable deposition technique disclosed herein. The amount of the hydrophobic polymer 48 that is applied to the inactive regions 14 is selected to be suitable for at least partially filling or fully filling the second depressions 30 in the inactive regions 14.

While not shown in FIG. 6F, in some instances, the protective coating 44 is removed from the active region(s) 12 (and in some instances, from the fluidic pinning regions 34) after the hydrophobic polymer 48 is applied within the inactive region(s) 14. Removal of the protective coating 44 may involve exposing the protective coating 44 to a suitable aqueous solvent, such as water.

After hydrophobic polymer 48 has been applied within the inactive regions 14 (and in some instances, after the protective coating 44 has been removed), any excess hydrophobic polymer 48 may be removed from the interstitial regions 32 and from the fluidic pinning region(s) 34, e.g., using a suitable polishing process disclosed herein. This is shown in FIG. 6G. As shown, the polishing of the substrate 18 or the layer 24 forms the hydrophobic barrier 42 within the second depressions 30 of the inactive regions 14. As further shown in FIG. 6E, the polishing leaves the polymeric hydrogel 36 (and in some instances, the protective coating 44) within the depressions 26, 30 and the hydrophobic barrier 42 within the second depressions 30 intact. It is to be understood that, depending on the desired height of the hydrophobic barrier 42, polishing may be controlled such that the hydrophobic barrier 42 protrudes from the depressions 32 in the inactive regions 14 (e.g., by limiting the polishing that is performed at the inactive regions 14) or extends across the interstitial regions 32.

In examples in which the protective coating 44 has not yet been removed (e.g., via dissolution or polishing), removal of the protective coating 44 may then be performed, as shown in FIG. 6H (e.g., via exposure to a suitable solvent disclosed herein).

In some of these examples, such as when a non-pre-grafted polymeric hydrogel 36 is applied to the active region(s) 12, the method proceeds by grafting primers 38A, 38B to the polymeric hydrogel 36 within the first depressions 26. During this process, the primers 38A, 38B do not become applied within the plurality of second depressions 30 in the inactive region(s) 14, due at least in part to the overlying hydrophobic barrier 42.

The primers 38A, 38B may be grafted using any suitable technique disclosed herein. Regardless of the particular grafting method that is used, the primers 38A, 38B react with reactive groups of the polymeric hydrogel 36, e.g., via chemical attachment to a functional group included therein.

The primers 38A, 38B may be any suitable pair of primers disclosed herein (e.g., P5 primers, P7 primers, P15 primers, PA-PD primers). As a result of grafting, the primers 38A, 38B will attach, at their 5′ end, to surface functional groups of the polymeric hydrogel 36, and will have no affinity for the exposed surfaces of the substrate 18 or layer 24 (e.g., the fluidic pinning region(s) 34 or the interstitial regions 28, 32) or for the hydrophobic barrier 42.

In some instances, the primers 38A, 38B are pre-grafted to the polymeric hydrogel 36, and thus the primers 38A, 38B are attached to the polymeric hydrogel 36 (or are included in the polymeric hydrogel mixture 36′) before the hydrogel 36 (or hydrogel mixture 36′) is applied over the substrate 18, 20. In these instances, additional primer grafting is not performed. Further in these instances, any primers 38A, 38B attached to the polymeric hydrogel 36 within the second depressions 30 are chemically suppressed by the presence of the overlying hydrophobic barrier 42, and thus these primers 38A, 38B will not interact with any biological reactants.

It is to be understood that some examples of the method shown in FIG. 6A through FIG. 6H are implemented using the single active region 12 with an inactive region 14 on either side, i.e., at opposite edges 40, 40′ (similar to the structure of FIG. 1C and FIG. 1E). However, in other examples, the method is implemented using two active regions 12 on either side of a single inactive region 14, where the single inactive region 14 prevents materials in one of the active regions 12 from mixing with materials in the other of the active regions 12 (similar to the structure of FIG. 1B and FIG. 1D). In these examples, the method is performed in the same manner as described in reference to examples that include two active regions 12 and a single inactive region 14, while accounting for the structural differences (in terms of the placement of the active regions 12 and the inactive region 14 and the corresponding deposition of the polymeric hydrogel 36 or mixture 36′ and the hydrophobic polymer 48).

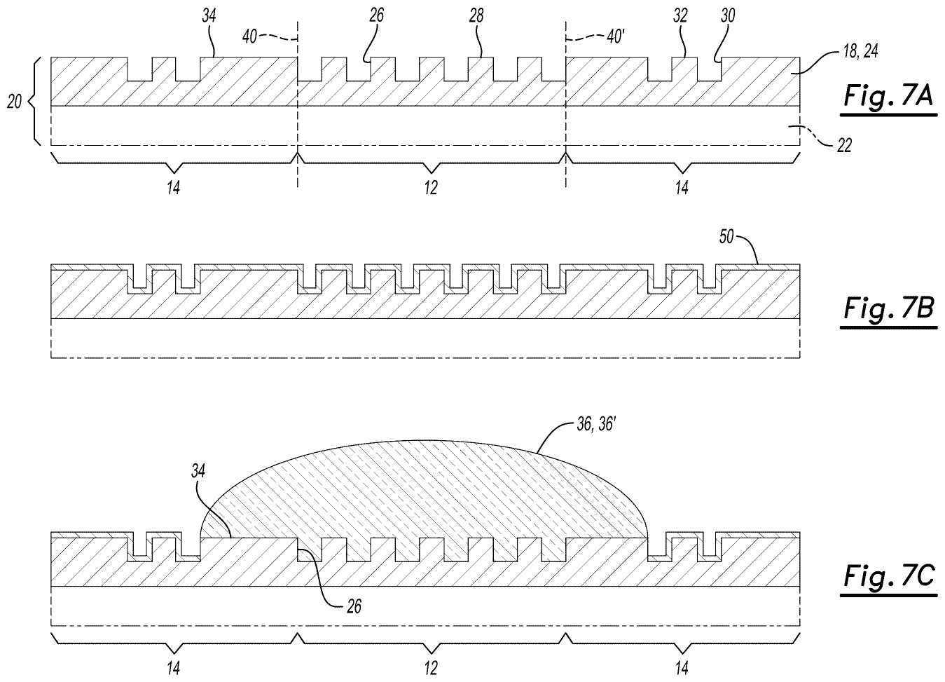

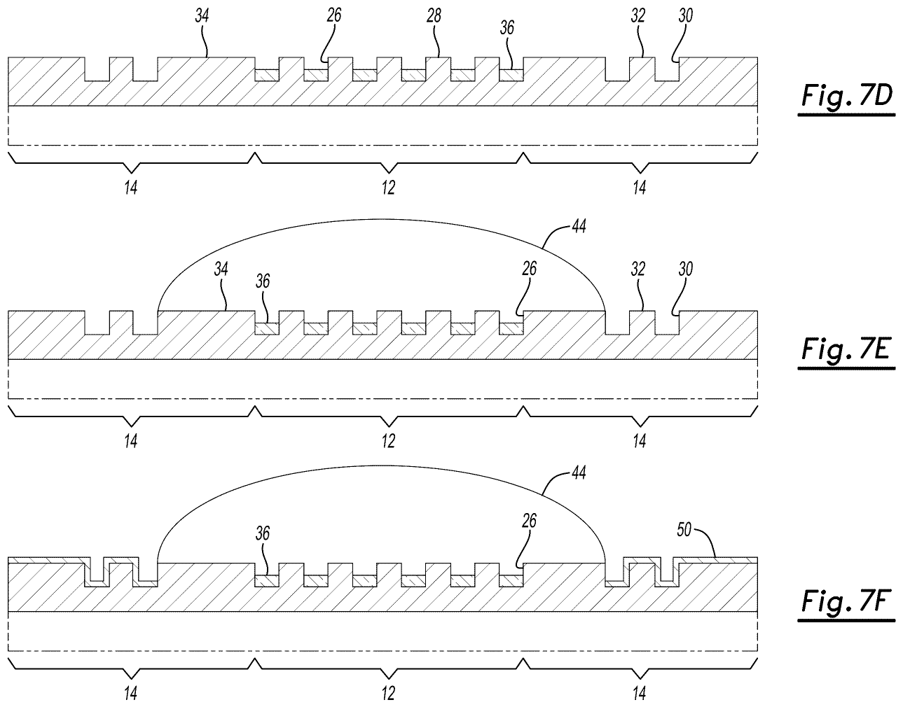

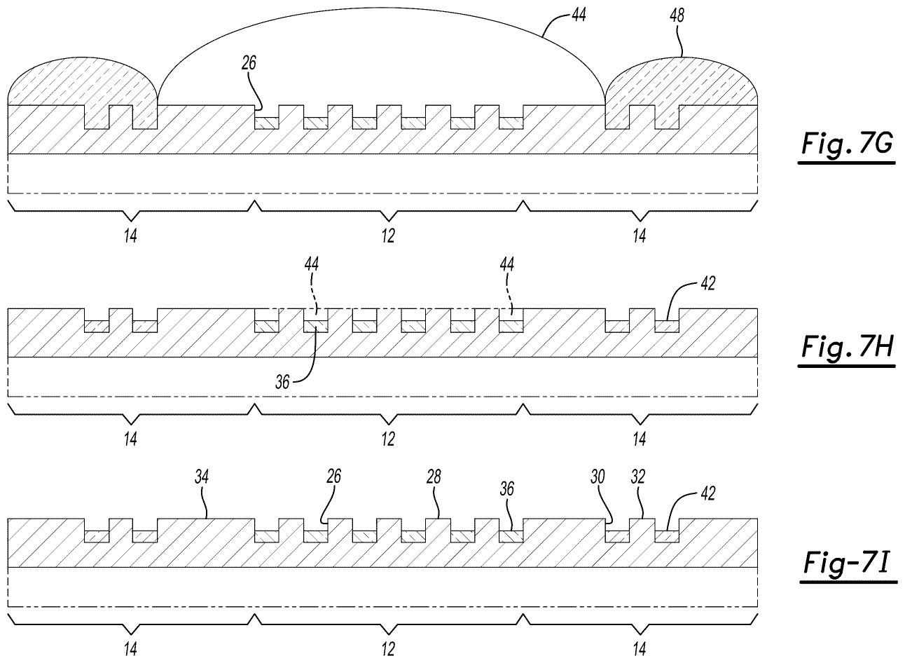

Yet another example of a method of preparing a flow cell 10 or 10′ that utilizes fluidic pinning and the hydrophobic barrier 42 is shown in FIG. 7A through FIG. 7I. This example method may be used as part of a process of forming the flow cell 10, 10′ described herein.

The example method shown in FIG. 7A through FIG. 7I generally involves: activating an active region 12 and an inactive region 14 of a substrate 18, 20, wherein the active region 12 includes a plurality of first depressions 26 separated by first interstitial regions 28, and wherein the inactive region 14 includes: a fluidic pinning region 34 that is directly adjacent to the active region 12; and a plurality of second depressions 30 that are separated by second interstitial regions 32, wherein at least some of the plurality of second depressions 30 are directly adjacent to the fluidic pinning region 34 (shown at FIG. 7B); applying a polymeric hydrogel 36 to the active region 12, whereby the polymeric hydrogel 36 at least partially fills the plurality of first depressions 26, becomes pinned within at least a portion of the fluidic pinning region 34, and does not advance into the plurality of second depressions 30 (shown at FIG. 7C); applying a protective coating 44 to the active region 12, whereby the protective coating 44 covers and passivates the polymeric hydrogel 36 that at least partially fills the plurality of first depressions 26 (shown at FIG. 7E); and applying a hydrophobic polymer 48 to the inactive region 14, whereby the hydrophobic polymer 48 at least partially fills the plurality of second depressions 30, thereby forming a hydrophobic barrier 42 in the inactive region 14 (shown at FIG. 7G through FIG. 7I).

The structure shown in FIG. 7A may include the single-layer substrate 18 or the multi-layer substrate 20 (including the base support 22 and the layer 24) and may be formed using any suitable patterning technique, such as nanoimprint lithography, photolithography, etching, etc. The patterning technique that is used to form the first depressions 26 (separated by the second interstitial regions 28) in the active region 12 and to form the second depressions 30 (separated by the second interstitial regions 32) in the inactive regions 14 will depend, in part, upon the material used for the substrate 18 or the layer 24 of the substrate 20. The structure shown in FIG. 7A may be generated in a manner similar to the technique described herein in reference to the structure of FIG. 3A (e.g., using a working stamp).

As shown in FIG. 7B, the structure of FIG. 7A may activated to include a surface functionality 50 (shown as a layer in the figures), which may be, as examples, a hydroxyl layer, an azide layer, an amino layer, a silane layer, a norbornene layer, or a functionality including a combination of any of these functional groups. Activation of the substrate 18 or of the layer 24 may introduce the surface functionality 50 to an entirety of the surface of the substrate 18 or layer 24, or activation may introduce the surface functionality 50 to the active region 12 and not to the inactive regions 14. Activation of the substrate 18 or the layer 24 may involve silanization and/or plasma ashing, as described in reference to the activation of the structure of FIG. 3B.

As shown in FIG. 7C, following activation of the substrate 18 or layer 24, the polymeric hydrogel 36 may then be introduced to the active region 12 of the substrate 18 or layer 24, such that the polymeric hydrogel 36 at least partially fills the plurality of first depressions 26 defined therein. The polymeric hydrogel 36 may be applied within a portion or an entirety of the fluidic pinning regions 34, but the polymeric hydrogel 36 does not advance into the second depressions 30 of the inactive regions 14. In some instances, the polymeric hydrogel 36 is first applied as a polymeric hydrogel mixture 36′, which can be subsequently dried or cured to form the polymeric hydrogel 36. The polymeric hydrogel mixture 36′, when used, may include any of the hydrogel materials disclosed herein.

The polymeric hydrogel 36 may be applied to the active region 12 (and in some instances, to the fluidic pinning regions 34) using any suitable selective deposition technique disclosed herein and in an amount that is suitable to partially or fully fill the plurality of first depressions 26.

As shown in FIG. 7D, following the application of the polymeric hydrogel 36, polishing may then be performed to remove the polymeric hydrogel 36 from the interstitial regions 28 separating the plurality of first depressions 26 within the active region 12, and in some instances, to remove the polymeric hydrogel 36 from the fluidic pinning region(s) 34. Polishing may be performed using a suitable technique described herein. Polishing leaves the polymeric hydrogel 36 within the plurality of first depressions 26 intact.

As shown in FIG. 7E, the protective coating 44 may then be selectively applied/deposited to the active region 12, such that the protective coating 44 covers the plurality of first depressions 26 defined in the active region 12. The protective coating 44 may also be applied to the fluidic pinning regions 34, but the protective coating 44 does not advance into the second depressions 30 of the inactive regions 14, due at least in part to the differential surface energy described herein. The protective coating 44 may first be applied as a protective coating mixture, which can be subsequently dried or cured to form the protective coating 44, and the mixture may include any of the suitable materials disclosed herein (and in any suitable respective amounts).

As shown in FIG. 7F, following the application of the protective coating 44 (or the protective coating mixture that forms the coating 44), activation of the inactive regions 14 of the substrate 18 or of the layer 24 may then be performed. As such, in examples, after the applying of the protective coating 44 to the active region 12 and before the applying of the hydrophobic polymer 48 to the inactive region 14, the method further comprises activating the inactive region 14 to facilitate attachment of the hydrophobic polymer 48 thereto. Activation of the inactive regions 14 may be performed using any suitable activation technique described herein, and the activation introduces the surface functionality 50 to the inactive regions 14. The surface functionality 50 is selected to be chemically reactive with a functional group that is included in the hydrophobic polymer 48 (that will be used to form the hydrophobic barrier 42) and may be any suitable example disclosed herein.

As shown in FIG. 7G, the hydrophobic polymer 48 is then applied to the inactive regions 14. As shown in the figure, the hydrophobic polymer 48 at least partially fills the second depressions 30 in the inactive region(s) 14 and may advance into a portion or an entirety of the fluidic pinning regions 34, but the hydrophobic polymer 48 does not advance into the adjacent active region 12, due at least in part to the presence of the protective coating 44 in the active region 12. As such, in this example, the protective coating 44 prevents the hydrophobic polymer 48 from becoming applied within the active region 12.

In an example, the hydrophobic polymer 48 is perfluoro (polytrimethylene) oxide trimethoxy silane (PPFTMS).

In some instances, following application of the hydrophobic polymer 48, heating or drying of the hydrophobic polymer 48 may be performed. The hydrophobic polymer 48 ultimately forms the hydrophobic barrier 42 in the inactive regions 14.

As mentioned, the positioning of the hydrophobic polymer 48 within the second depressions 30 may be facilitated by chemical attachment of the hydrophobic polymer 48 to the surface functionality 50 disposed within the second depressions 30.

The hydrophobic polymer 48 may be deposited in the inactive regions 14 using any suitable deposition technique disclosed herein. The amount of the hydrophobic polymer 48 that is applied to the inactive regions 14 is selected to be suitable for at least partially filling or fully filling the second depressions 30 in the inactive regions 14.

While not shown in FIG. 7G, in some instances, the protective coating 44 is removed from the active region 12 after the hydrophobic polymer 48 is applied within the inactive regions 14. Removal of the protective coating 44 may involve exposing the protective coating 44 to a suitable aqueous solvent, such as water.

After hydrophobic polymer 48 has been applied within the inactive regions 14 (and in some instances, after the protective coating 44 has been removed), excess hydrophobic polymer 48 may be removed from the interstitial regions 32 and from the fluidic pinning region(s) 34, e.g., using a suitable polishing process disclosed herein. This is shown in FIG. 7H. As shown, the polishing of the substrate 18 or the layer 24 forms the hydrophobic barrier 42 within the second depressions 30 of the inactive regions 14. As further shown in FIG. 7H, the polishing leaves the polymeric hydrogel 36 (and in some instances, the protective coating 44) within the depressions 26 intact, and the polishing also leaves the hydrophobic barrier 42 within the second depressions 30 intact. It is to be understood that, depending on the desired height of the hydrophobic barrier 42, polishing may be controlled such that the hydrophobic barrier protrudes from the depressions 30 in the inactive regions 14 (e.g., by limiting the polishing that is performed at the inactive regions 14) or extends over the interstitial regions 32.

In examples in which the protective coating 44 has not yet been removed (e.g., via dissolution or polishing), removal of the protective coating 44 may then be performed, as shown in FIG. 7I (e.g., via exposure to a suitable solvent disclosed herein).

In some of these examples, such as when a non-pre-grafted polymeric hydrogel 36 is applied to the active region 12, the method proceeds by grafting primers 38A, 38B to the polymeric hydrogel 36 within the first depressions 26.

The primers 38A, 38B may be grafted using any suitable technique disclosed herein. Regardless of the particular grafting method that is used, the primers 38A, 38B react with reactive groups of the polymeric hydrogel 36, e.g., via chemical attachment to a functional group included therein.

The primers 38A, 38B may be any suitable pair of primers disclosed herein (e.g., P5 primers, P7 primers, P15 primers, PA-PD primers). As a result of grafting, the primers 38A, 38B will attach, at their 5′ end, to surface functional groups of the polymeric hydrogel 36 within the active region 12, and will have no affinity for the exposed surfaces of the substrate 18 or layer 24 (e.g., the fluidic pinning region(s) 34 or the interstitial regions 28, 32) or for the hydrophobic barrier 42.

In some instances, the primers 38A, 38B are pre-grafted to the polymeric hydrogel 36, and thus the primers 38A, 38B are attached to the polymeric hydrogel 36 (or are included in the polymeric hydrogel mixture 36′) before the hydrogel 36 (or hydrogel mixture 36′) is applied over the substrate 18, 20. In these instances, additional primer grafting is not performed.

It is to be understood that some examples of the method shown in FIG. 7A through FIG. 7I are implemented using the single active region 12 with an inactive region 14 on either side, i.e., at opposite edges 40, 40′ (similar to the structure of FIG. 1C and FIG. 1E). However, in other examples, the method is implemented using two active regions 12 on either side of a single inactive region 14, where the single inactive region 14 prevents materials in one of the active regions 12 from mixing with materials in the other of the active regions 12 (similar to the structure of FIG. 1B and FIG. 1D). In these examples, the method is performed in the same manner as described in reference to examples that include two active regions 12 and a single inactive region 14, while accounting for the structural differences (in terms of the placement of the active regions 12 and the inactive region 14 and the corresponding deposition of the polymeric hydrogel 36 or mixture 36′ and the hydrophobic polymer 48).

It is to be understood that if it is desirable to form the flow cell 10′, any of the methods disclosed herein may further include attaching the substrate 18 or 20 to a CMOS chip 94. The attachment process may take place at the outset of the method, or at the end of the method.

### Additional Notes

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein. It should also be appreciated that terminology explicitly employed herein that also may appear in any disclosure incorporated by reference should be accorded a meaning most consistent with the particular concepts disclosed herein.

Reference throughout the specification to “one example”, “another example”, “an example”, and so forth, means that a particular element (e.g., feature, structure, and/or characteristic) described in connection with the example is included in at least one example described herein, and may or may not be present in other examples. In addition, it is to be understood that the described elements for any example may be combined in any suitable manner in the various examples unless the context clearly dictates otherwise.

While several examples have been described in detail, it is to be understood that the disclosed examples may be modified. Therefore, the foregoing description is to be considered non-limiting.

What is claimed is:

1. A flow cell, comprising:
a substrate including an active region that is directly adjacent to an inactive region, wherein:
the active region includes a hydrophilic material disposed within a plurality of first depressions that are separated by first interstitial regions; and
the inactive region includes:
a fluidic pinning region that is directly adjacent to the active region;
a plurality of second depressions that are separated by second interstitial regions, wherein at least some of the plurality of second depressions are directly adjacent to the fluidic pinning region; and
a hydrophobic barrier positioned over at least the plurality of second depressions, wherein the hydrophobic barrier includes a hydrophobic polymer.

2. The flow cell as defined in claim 1, wherein the hydrophobic polymer is perfluoro (polytrimethylene) oxide trimethoxy silane (PPFTMS).

3. The flow cell as defined in claim 1, wherein the hydrophilic material disposed within the plurality of first depressions includes a polymeric hydrogel.

4. A method, comprising:
activating an active region and an inactive region of a substrate,
wherein the active region includes a plurality of first depressions separated by first interstitial regions, and
wherein the inactive region includes:
a fluidic pinning region that is directly adjacent to the active region; and
a plurality of second depressions that are separated by second interstitial regions, wherein at least some of the plurality of second depressions are directly adjacent to the fluidic pinning region;
applying a polymeric hydrogel to the active region, whereby the polymeric hydrogel at least partially fills the plurality of first depressions, becomes pinned within at least a portion of the fluidic pinning region, and does not advance into the plurality of second depressions; and
applying a hydrophobic polymer to at least a portion of the inactive region, whereby the hydrophobic polymer at least partially fills the plurality of second depressions, thereby forming a hydrophobic barrier in the inactive region.

5. The method as defined in claim 4, wherein the polymeric hydrogel is applied to the active region before the hydrophobic polymer is applied to the inactive region.

6. The method as defined in claim 5, wherein after the polymeric hydrogel is applied to the active region and before the hydrophobic polymer is applied to at least the portion of the inactive region, the method further comprises applying a protective coating to the active region, whereby the protective coating covers and passivates the polymeric hydrogel.

7. The method as defined in claim 6, wherein the protective coating prevents the hydrophobic polymer from being applied within the active region during the applying of the hydrophobic polymer.

8. The method as defined in claim 4, wherein the polymeric hydrogel is applied to the active region after the hydrophobic barrier is formed in the inactive region.

9. The method as defined in claim 4, wherein the hydrophobic polymer is perfluoro (polytrimethylene) oxide trimethoxy silane (PPFTMS).

10. A method, comprising:
activating an active region and an inactive region of a substrate,
wherein the active region includes a plurality of first depressions separated by first interstitial regions, and
wherein the inactive region includes:
a fluidic pinning region that is directly adjacent to the active region; and
a plurality of second depressions that are separated by second interstitial regions, wherein at least some of the plurality of second depressions are directly adjacent to the fluidic pinning region;
applying a polymeric hydrogel to the active region and to the inactive region, whereby the polymeric hydrogel at least partially fills the plurality of first depressions and at least partially fills the plurality of second depressions;
applying a protective coating to the active region, whereby the protective coating covers and passivates the polymeric hydrogel that at least partially fills the plurality of first depressions; and
applying a hydrophobic polymer to the inactive region, whereby the hydrophobic polymer at least partially fills the plurality of second depressions and attaches to the polymeric hydrogel therein, thereby forming a hydrophobic barrier in the inactive region.

11. The method as defined in claim 10, wherein during the applying of the hydrophobic polymer, the protective coating prevents the hydrophobic polymer from being applied within the active region.

12. The method as defined in claim 10, wherein the hydrophobic polymer is perfluoro (polytrimethylene) oxide trimethoxy silane (PPFTMS).

13. A method, comprising:
activating an active region and an inactive region of a substrate,
wherein the active region includes a plurality of first depressions separated by first interstitial regions, and
wherein the inactive region includes:
a fluidic pinning region that is directly adjacent to the active region; and
a plurality of second depressions that are separated by second interstitial regions, wherein at least some of the plurality of second depressions are directly adjacent to the fluidic pinning region;
applying a polymeric hydrogel to the active region, whereby the polymeric hydrogel at least partially fills the plurality of first depressions, becomes pinned within at least a portion of the fluidic pinning region, and does not advance into the plurality of second depressions;
applying a protective coating to the active region, whereby the protective coating covers and passivates the polymeric hydrogel that at least partially fills the plurality of first depressions; and
applying a hydrophobic polymer to the inactive region, whereby the hydrophobic polymer at least partially fills the plurality of second depressions, thereby forming a hydrophobic barrier in the inactive region.

14. The method as defined in claim 13, wherein after the applying of the protective coating to the active region and before the applying of the hydrophobic polymer to the inactive region, the method further comprises activating the inactive region to facilitate attachment of the hydrophobic polymer thereto.


SEQUENCE LISTING (13 sequences)

SEQ ID NO: 1 - DNA, 29 bp, Synthetic construct
  modified_base 23: mod_base = OTHER; note = uracil
  source 1..29: mol_type = other DNA
aatgatacggcgaccaccgagatctacac

SEQ ID NO: 2 - DNA, 29 bp, Synthetic construct
  modified_base 23: mod_base = OTHER; note = alkene-thymidine
  source 1..29: mol_type = other DNA
aatgatacggcgaccaccgaganctacac

SEQ ID NO: 3 - DNA, 29 bp, synthetic construct
  modified_base 23: mod_base = i
  source 1..29: mol_type = other DNA
aatgatacggcgaccaccgaganctacac

SEQ ID NO: 4 - DNA, 24 bp, Synthetic construct
  modified_base 22: mod_base = OTHER; note = 8-oxoguanine
  source 1..24: mol_type = other DNA
caagcagaagacggcatacganat

SEQ ID NO: 5 - DNA, 24 bp, Synthetic construct
  source 1..24: mol_type = other DNA
  modified_base 20: mod_base = OTHER; note = 8-oxoguanine
caagcagaagacggcatacnagat

SEQ ID NO: 6 - DNA, 24 bp, synthetic construct
  modified_base 22: mod_base = OTHER; note = 8-oxoguanine
  source 1..24: mol_type = other DNA
  modified_base 20: mod_base = OTHER; note = 8-oxoguanine
caagcagaagacggcatacnanat

SEQ ID NO: 7 - DNA, 24 bp, Synthetic construct
  source 1..24: mol_type = other DNA
  modified_base 22: mod_base = OTHER; note = uracil
caagcagaagacggcatacgatat

SEQ ID NO: 8 - DNA, 24 bp, Synthetic construct
  modified_base 20: mod_base = OTHER; note = uracil
  source 1..24: mol_type = other DNA
caagcagaagacggcatactagat

SEQ ID NO: 9 - DNA, 29 bp, Synthetic construct
  modified_base 23: mod_base = OTHER; note = a thymine nucleotide analog having an allyl functionality
  source 1..29: mol_type = other DNA
aatgatacggcgaccaccgaganctacac

SEQ ID NO: 10 - DNA, 35 bp, Synthetic construct
  source 1..35: mol_type = other DNA
gctggcacgtccgaacgcttcgttaatccgttgag

SEQ ID NO: 11 - DNA, 35 bp, Synthetic construct
  source 1..35: mol_type = other DNA
cgtcgtctgccatggcgcttcggtggatatgaact

SEQ ID NO: 12 - DNA, 35 bp, Synthetic construct
  source 1..35: mol_type = other DNA
acggccgctaatatcaacgcgtcgaatccgcaact

SEQ ID NO: 13 - DNA, 34 bp, Synthetic construct
  source 1..34: mol_type = other DNA
gccgcgttacgttagccggactattcgatgcagc